(19) United States
(12) Patent Application Publication
(10) Pub. No.: US 2026/0246501 A1
(43) Pub. Date: Aug. 20, 2026

(54) MULTI-LAYER ADAPTATION TO ENHANCE JCS PERFORMANCE

(71) Applicant: QUALCOMM Incorporated, San Diego, CA (US)

(72) Inventors: Yuwei REN, Beijing (CN); Weimin DUAN, San Diego, CA (US); Hyojin LEE, San Diego, CA (US); Huilin XU, Beijing (CN)

(21) Appl. No.: 19/469,338

(22) PCT Filed: May 25, 2023
(86) PCT No.: PCT/CN2023/096239

§ 371 Date: Sep. 25, 2025

(51) Int. Cl. H04B 7/0413; G01S 13/76; H04W 72/0453; H04W 72/541

(52) U.S. Cl. CPC H04B 7/0413; G01S 13/765; H04W 72/0453; H04W 72/541

(57) ABSTRACT

Apparatuses and methods for multi-layer adaptation to enhance JCS performance are described. An apparatus is configured to provide, for a SMF, an adaptation capability. The adaptation capability indicates Tx capabilities for layer adaptation of the Tx of the apparatus in JCS. The apparatus is configured to receive, based on the adaptation capability, a layer configuration for at least one of a first set of layers or a second set of layers. The apparatus is configured to perform, based on the layer configuration, at least one of (1) a communication function, with a network node, via the first set of layers or (2) a sensing operation via the second set of layers in a detection mode or in a tracking mode.

### TECHNICAL FIELD

The present disclosure relates generally to communication systems, and more particularly, to wireless communications utilizing joint communication-sensing (JCS).

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus, which may be a user equipment (UE), is configured to provide, for a sensing management functionality (SMF), an adaptation capability, where the adaptation capability indicates at least one transmitter (Tx) capability of the UE for layer adaptation of the Tx of the UE in joint communication-sensing (JCS). The apparatus is also configured to receive, based on the adaptation capability, a layer configuration for at least one of a first set of layers or a second set of layers. The apparatus is further configured to perform, based on the layer configuration, at least one of (1) a communication function, with a network node, via the first set of layers or (2) a sensing operation via the second set of layers in a detection mode or in a tracking mode.

In the aspect, the method includes providing, for a SMF, an adaptation capability, where the adaptation capability indicates at least one Tx capability of the UE for layer adaptation of the Tx of the UE in JCS. The method also includes receiving, based on the adaptation capability, a layer configuration for at least one of a first set of layers or a second set of layers. The method further includes performing, based on the layer configuration, at least one of (1) a communication function, with a network node, via the first set of layers or (2) a sensing operation via the second set of layers in a detection mode or in a tracking mode.

In another aspect of the disclosure, a method, a computer-readable medium, and an apparatus are provided. The apparatus is configured to receive, from a UE, an adaptation capability, where the adaptation capability indicates at least one Tx capability of the UE for layer adaptation of the Tx of the UE in JCS. The apparatus is also configured to provide, for the UE and based on the adaptation capability, a layer configuration for at least one of a first set of layers or a second set of layers.

In the aspect, the method includes receiving, from a UE, an adaptation capability, where the adaptation capability indicates at least one Tx capability of the UE for layer adaptation of the Tx of the UE in JCS. The method also includes providing, for the UE and based on the adaptation capability, a layer configuration for at least one of a first set of layers or a second set of layers.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5 is a diagram illustrating examples of inter-layer interference and processing for JCS, in accordance with various aspects of the present disclosure.

FIG. 6 is a diagram illustrating examples of communications and sensing in JCS, in accordance with various aspects of the present disclosure.

FIG. 7 is a call flow diagram for wireless communications, in accordance with various aspects of the present disclosure.

FIG. 8 is a call flow diagram for wireless communications, in accordance with various aspects of the present disclosure.

FIG. 9 shows call flow diagrams for wireless communications, in accordance with various aspects of the present disclosure.

FIG. 10 is a flowchart of a method of wireless communication, in accordance with various aspects of the present disclosure.

FIG. 11 is a flowchart of a method of wireless communication, in accordance with various aspects of the present disclosure.

FIG. 12 is a flowchart of a method of wireless communication, in accordance with various aspects of the present disclosure.

FIG. 13 is a flowchart of a method of wireless communication, in accordance with various aspects of the present disclosure.

FIG. 14 is a diagram illustrating an example of a hardware implementation for an example apparatus and/or network entity.

FIG. 15 is a diagram illustrating an example of a hardware implementation for an example network entity.

FIG. 16 is a diagram illustrating an example of a hardware implementation for an example network entity.

### DETAILED DESCRIPTION

Wireless communication networks, such as a 5G NR network, may enable positioning measurements and operations to locate wireless devices and sensing targets. For example, a wireless device on a wireless communication network, and/or the like, may utilize JCS operations for communications and sensing. Configuring multiple layers for communication operations may increase information throughput, such as for data and control information. For multiple-input multiple-output (MIMO) operations, configurations such as single-user (SU) MIMO (SU-MIMO) and multi-user (MU) MIMO (MU-MIMO) may include transmitted signals with multiple layers. Similarly, signals transmitted via orthogonal frequency division multiplexing (OFDM) may include multiple layers.

However, configuring multiple layers for sensing operations may increase information throughput, however, it may also result in higher inter-layer interference therebetween and impact sensing performance (e.g., utilized power, accuracy, etc.).

That is, the inter-layer interference may be proportional to the number of layers in the sensing operations, and the power utilized by a sensing device/node may be increased with multiple layers to maintain a desired signal-to-noise ratio (SNR)/signal to interference and noise ratio (SINR). Further, the handling of inter-layer interference between layers may impact the performance of wireless systems and devices in, and on, a wireless communication network. For instance, increased complexity and time for inter-layer interference cancellation processing may impact system and device efficiency/performance, and may also increase delays in signal transmissions.

The aspects herein for multiple layer (multi-layer) adaptation to enhance JCS performance enable wireless network devices (e.g., sensing nodes) to more accurately and efficiently perform multi-layer sensing for JCS. For example, a sensing node (e.g., apparatus, device, etc.) may provide, for a SMF, an adaptation capability, where the adaptation capability indicates at least one Tx capability of the UE for layer adaptation of the Tx of the UE in JCS. The sensing node may also receive, based on the adaptation capability, a layer configuration for at least one of a first set of layers or a second set of layers. The sensing node may further perform, based on the layer configuration, at least one of (1) a communication function, with a network node, via the first set of layers or (2) a sensing operation via the second set of layers in a detection mode or in a tracking mode. As another example, a network entity (e.g., a base station, gNB, SMF, etc.) may receive, from a UE, an adaptation capability, where the adaptation capability indicates at least one Tx capability of the UE for layer adaptation of the Tx of the UE in JCS. The network entity may also provide, for the UE and based on the adaptation capability, a layer configuration for at least one of a first set of layers or a second set of layers.

Particular aspects of the subject matter described in this disclosure can be implemented to realize one or more of the following potential advantages. In one example, by providing a SMF with an adaptation capability that indicates at least one Tx capability of the UE for layer adaptation of the Tx of the UE in JCS, the described techniques can be used to adaptively configure layers for sensing operations at sensing nodes to reduce the inter-layer interference thereof and to reduce power utilization. In another example, by providing different implementations for triggering adaptive layers, sensing and sensing node performance improvements are enabled for multiple sensing scenarios. In yet another example, by providing flexible adaptation for layers, the extensible layer configurations herein are applicable to multiple sensing capabilities of sensing nodes, to monostatic and bistatic sensing, and to detection and tracking modes in sensing operations. In still another example, by providing sensing layer information, a wireless network and/or devices thereon (e.g., a base station, a sidelink UE, etc.) may adjust/improve multi-layer interference at sensing nodes and enhance sensing and communication performance.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

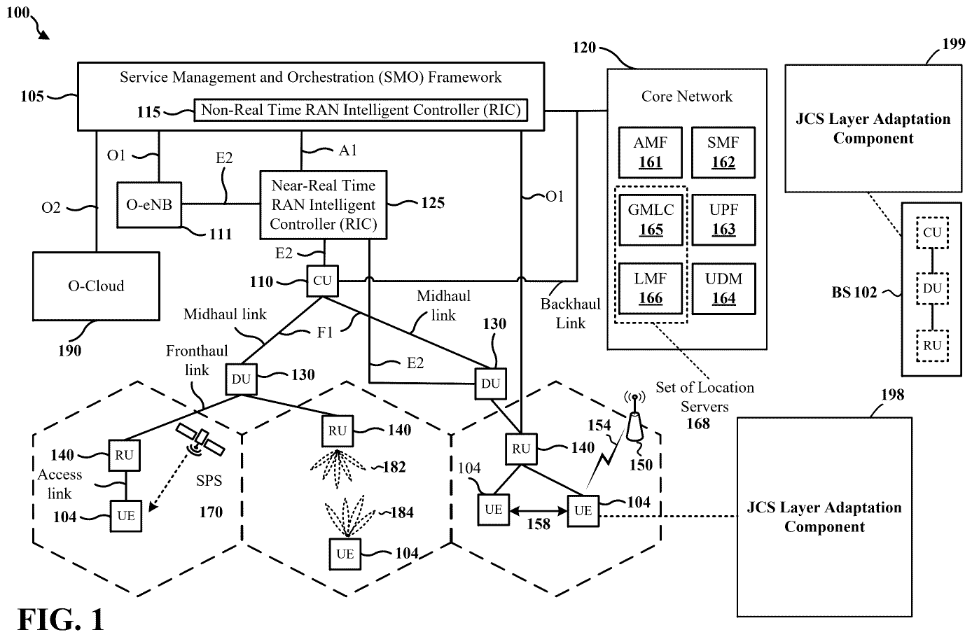

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell). Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a JCS layer adaptation component 198 (“component 198”) that may be configured to provide, for a sensing management functionality (SMF), an adaptation capability, where the adaptation capability indicates at least one transmitter (Tx) capability of the UE for layer adaptation of the Tx of the UE in joint communication-sensing (JCS). The component 198 may also be configured to receive, based on the adaptation capability, a layer configuration for at least one of a first set of layers or a second set of layers. The component 198 may be further configured to perform, based on the layer configuration, at least one of (1) a communication function, with a network node, via the first set of layers or (2) a sensing operation via the second set of layers in a detection mode or in a tracking mode. In certain aspects, the base station 102 may have a JCS layer adaptation component 199 (“component 199”) that may be configured to receive, from a UE, an adaptation capability, where the adaptation capability indicates at least one Tx capability of the UE for layer adaptation of the Tx of the UE in JCS. The component 199 may also be configured to provide, for the UE and based on the adaptation capability, a layer configuration for at least one of a first set of layers or a second set of layers. That is, aspects described herein for multi-layer adaptation to enhance JCS performance (e.g., via by providing a SMF with an adaptation capability that indicates at least one Tx capability of the UE for layer adaptation of the Tx of the UE in JCS, providing different implementations for triggering adaptive layers, by providing flexible adaptation for layers, and by providing sensing layer information) may provide enhancements to signaling accuracy, signaling latency, and/or processing power usage/complexity, as well as improving layer selection and utilization for types of sensing, specific cells, a bandwidth part (BWP)/BWPs used for sensing, and/or the like, while minimizing inter-layer interference between the layers and allowing for less power to obtain desired SNRs/SINRs.

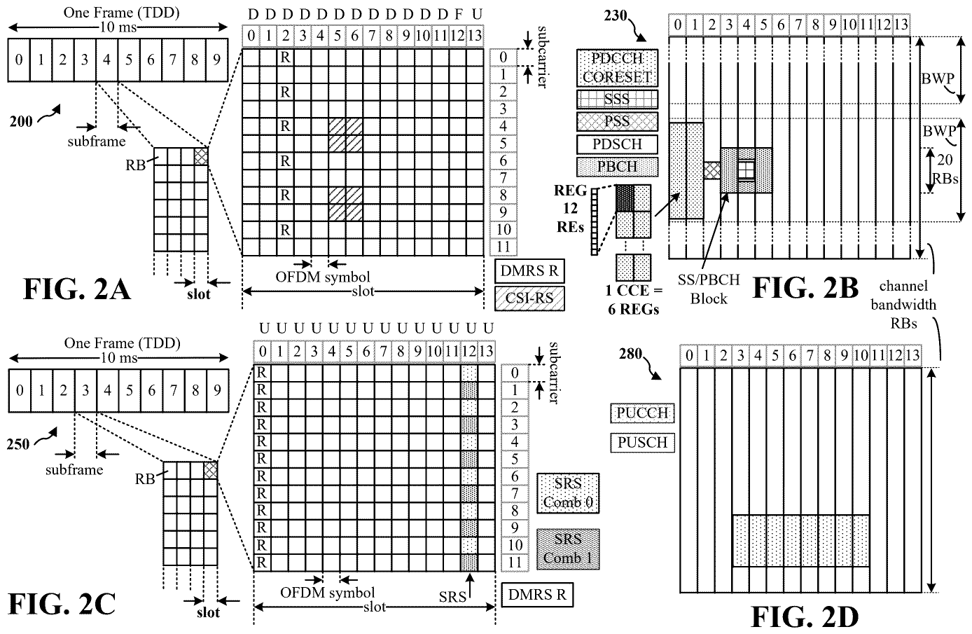

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 24 slots/subframe. The subcarrier spacing may be equal to 24*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

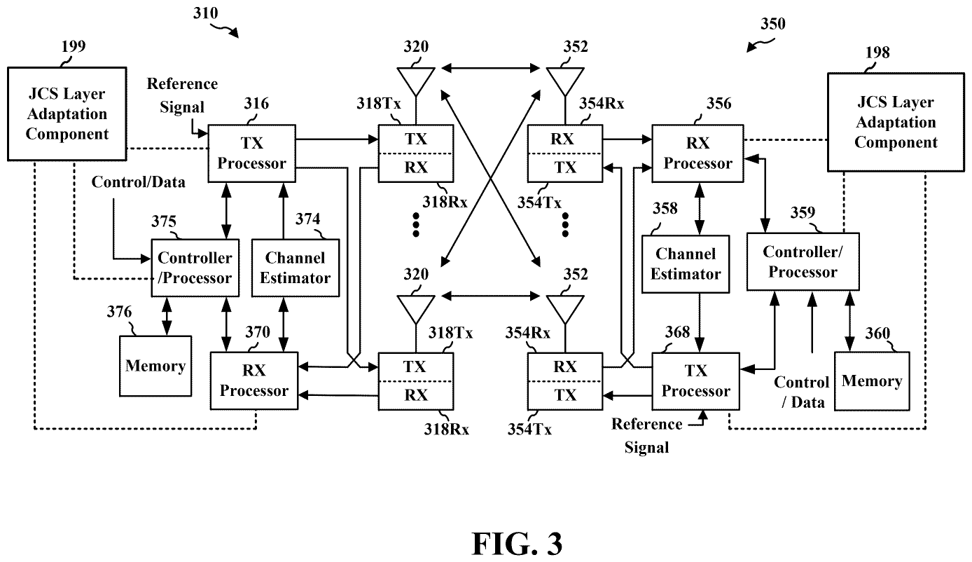

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the component 198 of FIG. 1. At least one of the TX processor 316, the RX processor 370, and the controller/processor 375 may be configured to perform aspects in connection with the component 199 of FIG. 1.

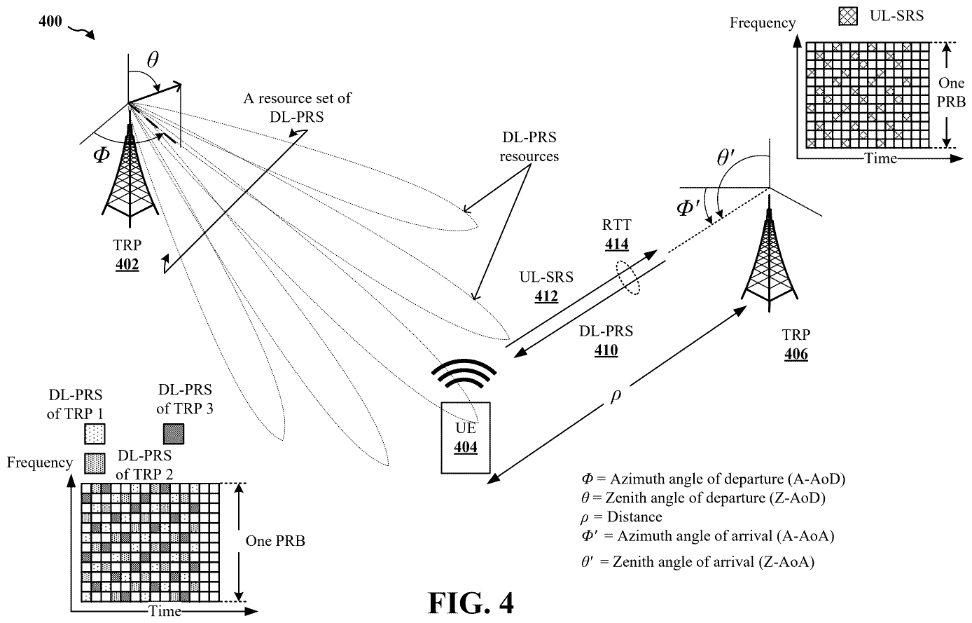

FIG. 4 is a diagram 400 illustrating an example of a UE positioning based on reference signal measurements. The UE 404 may transmit UL-SRS 412 at time TSRS_TX and receive DL positioning reference signals (PRS) (DL-PRS) 410 at time TPRS_RX. The TRP 406 may receive the UL-SRS 412 at time TSRS_RX and transmit the DL-PRS 410 at time TPRS_TX. The UE 404 may receive the DL-PRS 410 before transmitting the UL-SRS 412, or may transmit the UL-SRS 412 before receiving the DL-PRS 410. In both cases, a positioning server (e.g., location server(s) 168) or the UE 404 may determine the RTT 414 based on ∥TSRS_RX-TPRS_TX|−|TSRS_TX-TPRS_RX|. Accordingly, multi-RTT positioning may make use of the UE Rx-Tx time difference measurements (i.e., |TSRS_TX-TPRS_RX|) and DL-PRS reference signal received power (RSRP) (DL-PRS-RSRP) of downlink signals received from multiple TRPs 402, 406 and measured by the UE 404, and the measured TRP Rx-Tx time difference measurements (i.e., |TSRS_RX-TPRS_TX|) and UL-SRS-RSRP at multiple TRPs 402, 406 of uplink signals transmitted from UE 404. The UE 404 measures the UE Rx-Tx time difference measurements (and optionally DL-PRS-RSRP of the received signals) using assistance data received from the positioning server, and the TRPs 402, 406 measure the gNB Rx-Tx time difference measurements (and optionally UL-SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

DL-AoD positioning may make use of the measured DL-PRS-RSRP of downlink signals received from multiple TRPs 402, 406 at the UE 404. The UE 404 measures the DL-PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and optionally DL-PRS-RSRP) of downlink signals received from multiple TRPs 402, 406 at the UE 404. The UE 404 measures the DL RSTD (and optionally DL-PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and optionally UL-SRS-RSRP) at multiple TRPs 402, 406 of uplink signals transmitted from UE 404. The TRPs 402, 406 measure the UL-RTOA (and optionally UL-SRS-RSRP) of the received signals using assistance data received from the positioning server, and the resulting measurements are used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404.

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

In JCS operations for communications and sensing, configuring multiple layers for communication operations may increase information throughput, such as for data and control information (e.g., in MIMO operations: SU-MIMO and/or MU-MIMO). Similarly, signals transmitted/received via OFDM may include multiple layers. However, while configuring multiple layers for sensing operations may increase information throughput, it may also result in higher inter-layer interference therebetween and impact sensing performance (e.g., accuracy, power usage, etc.) due to the inter-layer interference being proportional to the number of layers in the sensing operations. The handling of inter-layer interference between layers may also impact the performance of wireless systems and wireless devices through increased complexity and time for inter-layer interference cancellation processing (e.g., impacts system and device efficiency/performance), and may also increase delays in signal transmissions.

Aspects described herein for multi-layer adaptation to enhance JCS performance may provide enhancements to signaling accuracy, signaling latency, and/or processing power usage/complexity, as well as improving layer selection and utilization for types of sensing, specific cells, a BWP(s), layers, etc., used for sensing, and/or the like, while minimizing inter-layer interference between the layers and allowing for less power to obtain desired SNRs/SINRs. Accordingly, aspects introduce configurations for multi-layer adaptation to enhance JCS performance, e.g., in communications and/or sensing operations, that allow for sensing accuracy and efficiency, as well as flexibility in configuring for cells/BWPs/layers, while mitigating impacts for inter-layer interference between the layers. For instance, the aspects described provide for a sensing node to be configured based on its multi-layers sharing/adaptation capabilities, which may be associated with a number of layers for cells, sensing modes, and/or BWPs that are utilized in sensing operations, e.g., mono-/bi-static sensing, based on configured layer sharing parameters.

In aspects, a sensing operation may be an operation where a sensing node transmits a sensing signal/waveform, e.g., a waveform by which the sensing of targets may be performed (e.g., radio assisted detection and ranging/radio detection and ranging (RADAR)), via reflections/echo (e.g., monostatic) and/or other interactions of the transmission itself with the target (bistatic). In aspects, a communication operation may be an operation where a wireless device, base station, and/or the like, transmit and/or receive data/control communications via communication waveforms (e.g., a waveform by which the data/control communications may be provided, such as OFDM). Corresponding sensing measurement data for targets based on the selected number of layers provide both sensing accuracy and reduced operation complexity/latency. Aspects may provide for a sensing node (e.g., a UE, a base station, a gNB, etc.) to receive layer configuration elements (e.g., via RRC signaling), which may configure the number of layers per a given cell, BWP (e.g., PRB), sensing mode, etc. Aspects may also provide layer configurations for numbers of layers based on the type of the sensing operations, e.g., mono-/bi-static sensing, the sensing mode, etc., and may provide selection rules in configurations for simultaneously enabled mono-/bi-static sensing in a given resource. Utilizing the configurations for multi-layer adaptation to enhance JCS performance, the described aspects may maintain sensing accuracy with minimal impact to processing efficiency/power usage due to inter-layer interference between the layers.

While various aspects may be described in the context of configurations to adapt JCS multi-layer interferences for descriptive and illustrative purposes, aspects are not so limited and may be applicable to other types of resources and operations, as would be understood by persons of skill in the relevant art(s) having the benefit of this disclosure.

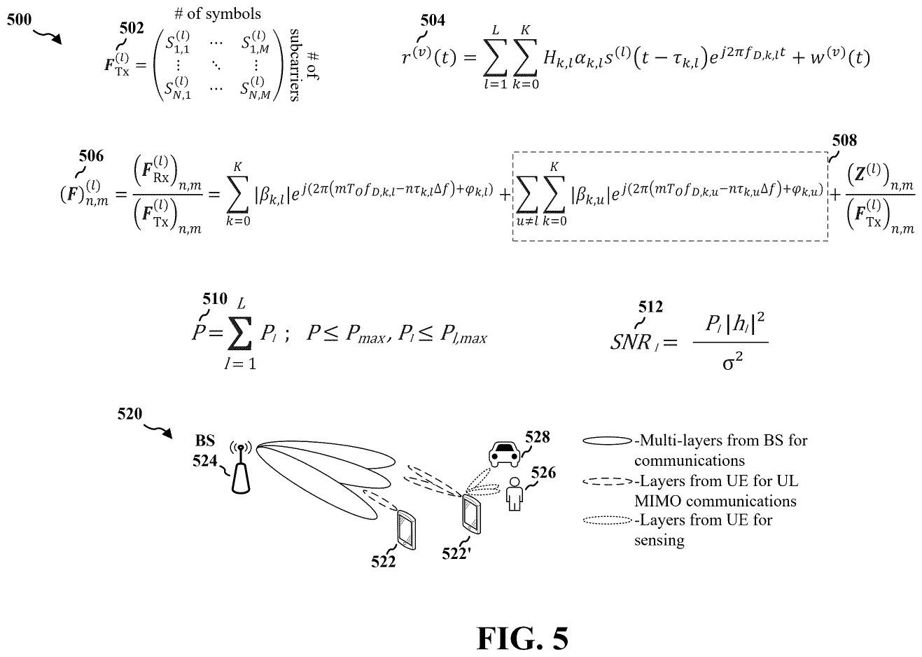

FIG. 5 is a diagram 500 illustrating examples of multi-layer adaptation to enhance JCS performance, in accordance with various aspects of the present disclosure. When multiple layers are configured in JCS for sensing, the inter-layer interference may impact the sensing performance. For SU-MIMO and MU-MIMO operations, transmitted signals may have multiple layers. As shown in diagram 500, by way of example and with reference to a configuration 520, a representation 502, with columns of numbers of probing signals and rows of numbers of subcarriers, may represent a number of layers for a transmitted signal in multi-layer OFDM within a layer index ‘1’.

Likewise, received signals may include multiple layers. With reference to a representation 504 in diagram 500, a demodulation reference signal (DMRS) may be transmitted and received with orthogonal resources for different layers, and data tones for different layers may be super-positioned on received antennas (where ‘v’ is the Rx antenna index). Subsequent to CP removal, FFT processing, and MIMO equalization, the representation 504 may be reformed as a representation 506 that includes an inter-layer interference element 508. By applying a two dimensional FFT to representation 506, the delay-Doppler profile may be determined, followed by post processing to yield sensing information. With reference to DL power control in the multi-layers for SU-MIMO and/or MU-MIMO, each separate power control for each layer may be enabled for one specific coverage, direction, Rx, etc. The power allocation may be defined as a representation 510, where P is the overall DL power, and Pₗ is the allocated power for one specific l-th layer. In the representation 510, Pmax is the overall maximum Tx power, and P_{l,max} is the maximum Tx power per layer. The SNR may be defined as a representation 512, where SNRₗ is the corresponding SNR for the l-th layer, and |hₗ|² is the beamforming gain. Accordingly, as noted herein, with more layers (e.g., beams, directions, etc.) for sensing and communication, there is more power consumption for the specific coverage.

That is, when encountering multi-layer interference in JCS, e.g., as represented by inter-layer interference element 508 that may be proportional to the number of layers utilized in the signal, inter-layer cancellation may be leveraged to enhance the restored sensing information. The inter-layer interference element 508 may represent interference between communication layers, sensing layers, and/or a combination thereof. The configuration 520 in diagram 500 illustrates an example of multiple layers for JCS in communications/sensing for a UE(s) (e.g., a UE 522, a UE 522′, etc.) and a base station (e.g., a base station 524). The configuration 520 shows multi-layers from the base station 524 for communications, layers from the UE 522 and the UE 522′ for UL MIMO communications with the base station 524, and layers from the UE 522 and the UE 522′ for sensing of a first sensing target 526 and a second sensing target 528. As noted herein, more layers can support more directions with one beam pattern design, yet more layers may generally degrade the beamforming gain in one direction, which may use larger power to meet the SNR constraint, and more layers may also lead to high (er) inter-layer interference. Simply put, more layers may lead to large power consumption in multi-layers.

When JCS is enabled in a resource, some layers may be configured simultaneously to support the communications and the sensing operations. For example, shown in the diagram 500, five layers may be enabled overall, where three layers are specifically designed for sensing operations to provide coverage for three directions for the UE 522′, while the UE 522′ has two layers scheduled for communication.

In the case of bistatic sensing, the transmitted signal on each layer may first be detected by a base station or UE in order to have knowledge thereof. A base station or UE may first, as additional operations/processes, reconstruct the ideal (or true) data, and further, may differentiate the reconstructed data with the received data. Such processing may be highly dependent on the base station or UE self-implementation, and such implementation may include large additional effort, processing, time, etc., to extract the sensing information. Thus, the UE capability and operation may be impacted. As one example, interference cancellation complexity may severely impact a receiver (Rx) of a UE.

Different challenges for multi-layers sharing being enabled in JCS, are reduced/eliminated by the aspects herein for multi-layer adaptation to enhance JCS performance. For example, inter-layer interference may lead the low SINR for communications or sensing, and in order to ensure the coverage for the sensing, more layers may cause the high-power consumption. Additionally, different sensing specifications for the detection mode and/or tracking mode in sensing operations may impact the layers and power configuration in the JCS. Such costs may constrain the application of more layers in JCS.

When multi-layers are configured in JCS for sensing, the inter-layer interference would impact the sensing performance. In one aspect, we propose an adaptive layer configuration to enhance JCS performance. If able, the UE reports its capability for the layer adaptation in the JCS. Based on different traffic and conditions, a SMF configures the number of sensing layers at the sensing nodes. An option for switching between detection mode and tracking mode may be selected.

Accordingly, aspects herein enable adaptive layer configuration to enhance performance in JCS. For instance, aspects provide for layer adaptation for different sensing specifications, provide for rules and signaling to support the adaptation of the sensing layers, including but not limited to a related UE capability (ies), separate sensing layer configurations for the detection mode and the tracking mode, defined sensing-layers dependent on BWPs, and/or the like, as described herein. Further, aspects provide for rules to trigger the switching of the sensing modes to adapt different scenarios, sensing layer information may be provided to assist the interference reduction in the communication layers, and the related interference reporting may enhance the sensing and communication performance.

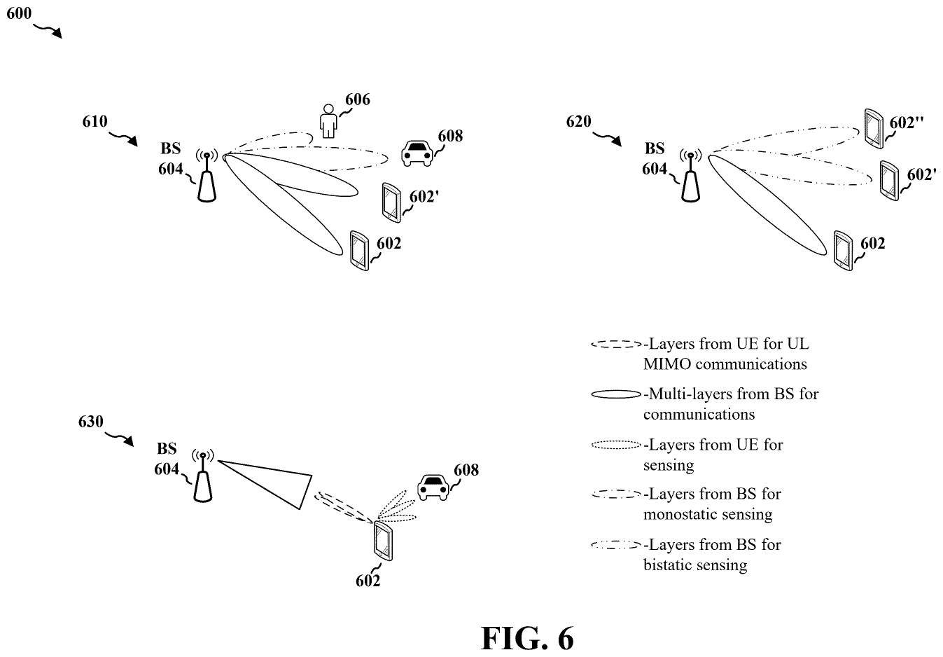

FIG. 6 is a diagram 600 illustrating examples of communications and sensing in JCS, in various aspects. Diagram 600 shows such examples in the context of a UE 602, a UE 602′, and/or a UE 602″ for communications/sensing, with or without a base station 604. When multi-layers are shared for the sensing operations and the communications, there may be three general scenarios: a scenario 610, a scenario 620, and a scenario 630.

In the scenario 610, the base station 604 is enabled to share multilayers for sensing and communications. In such scenario, the mono-static DL sensing via layers from the base station 604 for monostatic sensing of a sensing target 606 and/or a sensing target 608 may be transparent to the UE 602 and the UE 602′. In the scenario 620, bistatic sensing is enabled between the base station 604 and one or more UEs (e.g., the UE 602′ and/or the UE 602″, where a portion of the layers from the base station 604 for bistatic sensing are used. Such sensing signals may be sent from the UE 602′ and/or the UE 602″ to the base station 604 in UL and/or from the base station 604 to the UE 602′ and/or the UE 602″ in DL, while the UE 602 may utilize multi-layers from the base station 604 for communications. In the scenario 630, UE-centric monostatic sensing is illustrated, where some layers at the UE 602 side are enabled for monostatic sensing of the sensing target 608, while the UE 602 may also communicate via UL with the base station 604 through layers from the UE 602 for UL MIMO communications.

While configuring multiple layers for sensing operations may increase information throughput, however, it may also result in higher inter-layer interference therebetween and impact sensing performance (e.g., utilized power, accuracy, etc.), where the inter-layer interference may be proportional to the number of layers in the sensing operations, and the power utilized by a sensing device/node may be increased with multiple layers to maintain a desired SNR/SINR. The handling of inter-layer interference between layers may impact the performance of wireless systems and devices in, and on, a wireless communication network. For instance, increased complexity and time for inter-layer interference cancellation processing may impact system and device efficiency/performance, and may also increase delays in signal transmissions.

The aspects herein may relate to multi-layer adaptation to enhance JCS performance by which a sensing node (e.g., apparatus, device, etc., such as a UE, a base station, a gNB, and/or the like) may provide, for a SMF, an adaptation capability, where the adaptation capability indicates at least one Tx capability of the sensing node for layer adaptation of the Tx of the sensing node in JCS. The sensing node may also receive, based on the adaptation capability, a layer configuration for at least one of a first set of layers or a second set of layers based on which the sensing node may perform a communication function via the first set of layers and/or a sensing operation via the second set of layers in a detection mode or in a tracking mode. A network entity (e.g., a base station, gNB, SMF, etc.) may receive, from a sensing node (e.g., UE), an adaptation capability that indicates at least one Tx capability of the sensing node for layer adaptation in JCS. The network entity may also generate and provide, for the UE and based on the adaptation capability, the layer configuration for the first set of layers and/or the second set of layers.

In the aspects described herein, by providing a SMF with an adaptation capability that indicates at least one Tx capability of the UE for layer adaptation of the Tx of the UE in JCS, the described techniques can be used to adaptively configure layers for sensing operations at sensing nodes to reduce the inter-layer interference thereof and to reduce power utilization. Further, by providing different implementations for triggering adaptive layers, sensing and sensing node performance improvements are enabled for multiple sensing scenarios, and by providing flexible adaptation for layers, the extensible layer configurations herein are applicable to multiple sensing capabilities of sensing nodes, to monostatic and bistatic sensing, and to detection and tracking modes in sensing operations. Moreover, by providing sensing layer information, a wireless network and/or devices thereon (e.g., a base station, a sidelink UE, etc.) may adjust/improve multi-layer interference at sensing nodes and enhance sensing and communication performance.

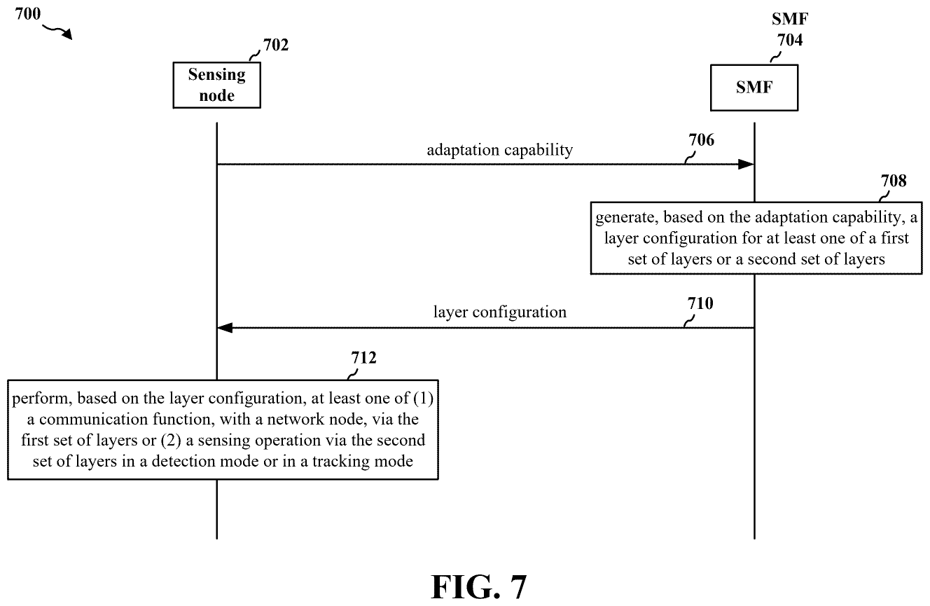

FIG. 7 is a call flow diagram 700 for wireless communications, in various aspects. Call flow diagram 700 illustrates multi-layers adaptation to enhance JCS performance for a sensing node (e.g., a sensing node 702, such as a UE, a gNB, a base station, etc.) that may communicate with a SMF 704 (e.g., as a core network component for managing sensing sessions and sensing node configurations for multi-layers sharing), and that may communicate and/or perform sensing operations via JCS, with or without a network node (e.g., a base station, such as a gNB or other type of base station, by way of example, as shown). Aspects described for the SMF 704 may be performed by the SMF 704 in aggregated form and/or by one or more components of the SMF 704 in disaggregated form. Additionally, or alternatively, the aspects may be performed by the sensing node 702 autonomously, in addition to, and/or in lieu of, operations of the SMF 704.

A sensing operation may include two stage modes: a detection mode and/or a tracking mode. In the detection mode, the sensing node 702 may mainly detect whether there are potential sensing targets in wide coverage, which may not utilize high accuracy and/or high granularity for sensing. In some such sensing operations, a single layer may be enough to accomplish the detecting. In the tracking mode, the sensing node 702 may simultaneously track one or multiple sensing targets with high accuracy and/or granularity request. In some such sensing operations, additional layers may be enabled.

In the illustrated aspect, the sensing node 702 may be configured to provide, for the SMF 704, an adaptation capability 706. The adaptation capability 706 may indicate at least one Tx capability of the sensing node 702 for layer adaptation of its Tx in JCS. In aspects, elements of the adaptation capability 706 may include, but is not limited to, the following. A first indication (e.g., 1 bit) may be included to show whether the sensing node 702 supports MIMO-layers sharing in JCS for its Tx, e.g., a “layers_sharing_indication.” In the context of the aspects herein, MIMO-layers sharing may mean that some layers are triggered for sensing, and some layers are simultaneously enabled for communication. A second indication (e.g., M bits) may be included to indicate a maximum number of layers for sensing operations when MIMO-layers sharing is enabled. A third indication (e.g., N1 bits) may be included to indicate a maximum number of layers for sensing operations in the detection mode. A fourth indication (e.g., N2 bits) may be included to indicate a maximum number of layers for sensing operations in the tracking mode.

In some aspects, the adaptation capability 706 may indicate at least one Rx capability of the sensing node 702 (e.g., a UE) for the layer adaptation of the Rx for MIMO-layers sharing in the JCS. The MIMO-layers sharing in the JCS may be associated with at least one of communication layers or sensing layers. The Rx capability of the sensing node 702 for the layer adaptation of the Rx for the MIMO-layers sharing in the JCS associated with the communication layers may indicate at least one of a first indication of support for the communication layers when the sensing layers are simultaneously enabled and/or a second indication of support to handle inter-layer interference in the communication layers from the sensing layers. The Rx capability of the sensing node 702 for the layer adaptation of the Rx for the MIMO-layers sharing in the JCS associated with the sensing layers may indicate at least one of a first indication of support for the sensing layers when the communication layers are simultaneously enabled and/or a second indication of support to handle inter-layer interference in the sensing layers from the communication layers.

In aspects, the adaptation capability 706 may be provided/reported to the SMF 704. Elements of the adaptation capability 706 may be utilized by the network (e.g., the SMF 704) to schedule the sensing node 702 with resources for sensing and communications, to manage the interference among the sensing and communications, and/or as further described herein. For example, when a UE-centric monostatic sensing is considered, and MIMO-layers sharing is enabled, 3 layers (e.g., beams) may be enabled for sensing operations, and 2 layers (e.g., beams) may be enabled for communication, as shown for scenario 630 in FIG. 6, which is described above.

The SMF 704 may be configured to generate (at 708), based on the adaptation capability 706 provided by the sensing node 702, a layer configuration 710 for at least one of a first set of layers or a second set of layers. For example, based on the capability of the sensing node 702 for one or more of support for MIMO-layers sharing in JCS for its Tx, a maximum layers for sensing operations when MIMO-layers sharing is enabled, a maximum layers for sensing operations in the detection mode, and/or a maximum layers for sensing operations in the tracking mode, the SMF 704 may generate (at 708) the layer configuration 710. The SMF 704 may provide/transmit the layer configuration 710 to the sensing node 702.

The sensing node may be configured to perform (at 712), based on the layer configuration 710, at least one of (1) a communication function, with a network node, via the first set of layers or (2) a sensing operation via the second set of layers in a detection mode or in a tracking mode. The sensing operation may be a monostatic or bistatic (e.g., in association with a base station) sensing operation.

In aspects, for monostatic sensing operations, the sensing node 702 may be configured to provide/transmit sensing layer information associated with the monostatic sensing via at least one layer of the first set of layers. The sensing layer information may include at least one of a status indication of MIMO-layers sharing in the JCS for the sensing node 702, a first number of sensing layers associated with the detection mode, a second number of sensing layers associated with the tracking mode, and/or at least one waveform respectively associated with at least one of the detection mode or the tracking mode. Providing the sensing layer information may include providing the sensing layer information for at least one of (i) a network node via a UE-to-universal mobile telecommunications system (UMTS) terrestrial radio access network (UTRAN) (Uu) interface or (ii) another sensing node (e.g., a sidelink UE) via a sidelink connection. As noted herein, a base station and/or a sidelink UE may utilize the sensing layer information to adjust/improve multi-layer interference at the sensing node 702 and enhance sensing and communication performance, e.g., by using configured layer sharing parameters for the sensing node 702.

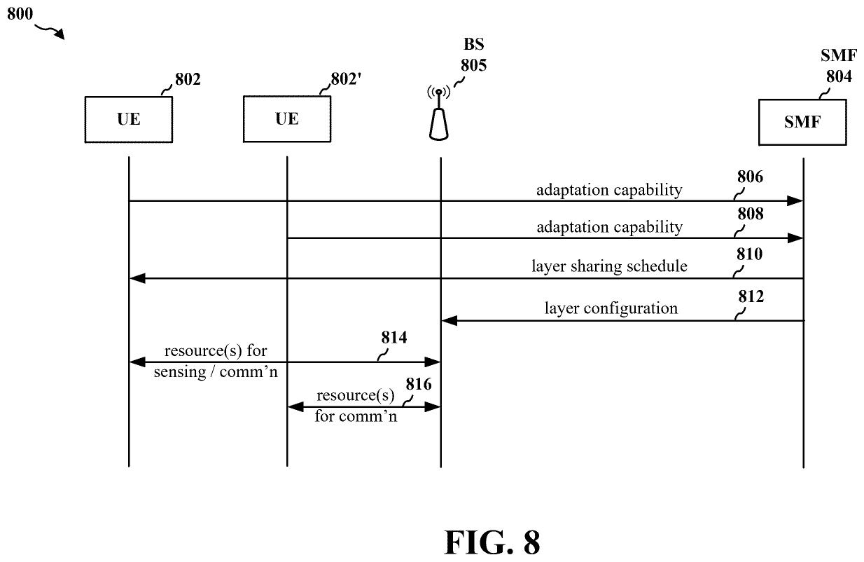

FIG. 8 is a call flow diagram 800 for wireless communications, in various aspects. Call flow diagram 800 illustrates multi-layers adaptation to enhance JCS performance for a UE(s) (e.g., a UE 802 and/or a UE 802′, which may be sensing nodes) that may communicate with a SMF 804 (e.g., as a core network component for managing sensing sessions and UE/sensing node configurations for multi-layers sharing), and that may communicate and/or perform sensing operations via JCS, with or without a network node (e.g., a base station 805, such as a gNB or other type of base station, by way of example, as shown). Aspects described for the SMF 804 and/or the base station 805 may be performed by the SMF 804 and/or the base station 805 in aggregated form and/or by one or more components of the SMF 804 and/or the base station 805 in disaggregated form. Additionally, or alternatively, the aspects may be performed by the UE 802 autonomously, in addition to, and/or in lieu of, operations of the SMF 804 and/or the base station 805. Call flow diagram 800 may be a further aspect of the call flow diagram 700 in FIG. 7.

Generally, for MIMO-layer sharing in prior solutions, the Rx for a sensing node may be scheduled for the communication or for the sensing, but not both. That is, the inter-layer interference from sensing layers is a challenge for the scheduled UE to manage/mitigate in the communication layers. For example, some low-tier UEs have difficulty removing the impact of the interference from sensing layers.

In some configurations, the UE 802 and/or the UE 802′ may initially be in communication with the base station 805 with sensing not enabled. In the illustrated aspect, the UE 802 may be configured to provide, for the SMF 804, an adaptation capability 806. The adaptation capability 806 may indicate at least one Tx capability of the UE 802 for layer adaptation of its Tx in JCS, as similarly described above for the adaptation capability 706 in the call flow diagram 700 of FIG. 7. Likewise, the UE 802 may be configured to provide, for the SMF 804, its own adaptation capability 808. For purposes of the illustrated example, the UE 802 may include one or more capabilities/elements in the adaptation capability 806 that indicate multi-layers sharing in JCS is supported, while the UE 802′ 802 may not include one or more capabilities/elements in the adaptation capability 806 to indicate multi-layers sharing in JCS is supported (i.e., UE 802′ may not support multi-layers sharing in JCS).

In some aspects, the adaptation capability 806 may indicate at least one Rx capability of the UE 802 (e.g., a sensing node) for the layer adaptation of the Rx for MIMO-layers sharing in the JCS. The MIMO-layers sharing in the JCS may be associated with at least one of communication layers or sensing layers. The Rx capability of the UE 802 for the layer adaptation of the Rx for the MIMO-layers sharing in the JCS associated with the communication layers may indicate at least one of a first indication of support for the communication layers when the sensing layers are simultaneously enabled and/or a second indication of support to handle inter-layer interference in the communication layers from the sensing layers. The Rx capability of the UE 802 for the layer adaptation of the Rx for the MIMO-layers sharing in the JCS associated with the sensing layers may indicate at least one of a first indication of support for the sensing layers when the communication layers are simultaneously enabled and/or a second indication of support to handle inter-layer interference in the sensing layers from the communication layers.

Elements of the adaptation capability 806 may be utilized by the network (e.g., the SMF 804) to schedule the UE 802 with resources for sensing and communications, to manage the interference among the sensing and communications, and/or as further described herein. For example, when a UE-centric monostatic sensing is considered, and MIMO-layers sharing is enabled, 3 layers (e.g., beams) may be enabled for sensing operations, and 2 layers (e.g., beams) may be enabled for communication, as shown for scenario 630 in FIG. 6, which is described above.

In configurations where the UE 802 includes one or more capabilities/elements in the adaptation capability 806 that indicate multi-layers sharing in JCS is supported, the SMF 804 may provide/transmit, for the UE 802 and based on the adaptation capability 806, a layer sharing schedule 810 that schedules the UE for communication layers and sensing layers in JCS. For example, and as illustrated, when some communication UEs are scheduled, the UE 802 has the capability to support the shared layers in the Rx, which means that the UE 802 can remove the interference from sensing layers, as discussed above. The UE 802′ may be a low-tier UE, and may not be capable to handle the interference from sensing layers. Thus, the UE 802 may be scheduled in the resource with multi-layers sharing for communication and sensing operations, while the UE 802′ may be scheduled in the resource for the communications but not for sensing operations.

The SMF 804 may be configured to generate, based on the adaptation capability 806 provided by the UE 802, a layer configuration 812 for at least one of a first set of layers or a second set of layers. For example, based on the capability of the UE 802 for one or more of support for MIMO-layers sharing in JCS for its Tx/RX, a maximum layers for sensing operations when MIMO-layers sharing is enabled, a maximum layers for sensing operations in the detection mode, and/or a maximum layers for sensing operations in the tracking mode, the SMF 804 may generate the layer configuration 812. The SMF 804 may provide/transmit the layer configuration 812 to the base station 805 for the UE 802. Thus, the UE 802 may utilize resources 814 for sensing operations and communications (e.g., associated with the UE 802 and/or with the base station 805), while the UE 802′ may utilize resources 816 for and communications (e.g., associated with the base station 805).

Accordingly, the aspects described above for FIGS. 7, 8 are related to Rx/Tx capabilities of sensing nodes that are reported to a SMF for multi-layers in JCS, and the signals in the sensing layers are different from those in the communication layers. Therefore, aspects provide for defining the specific capability when multi-layers are shared for communication and sensing operations.

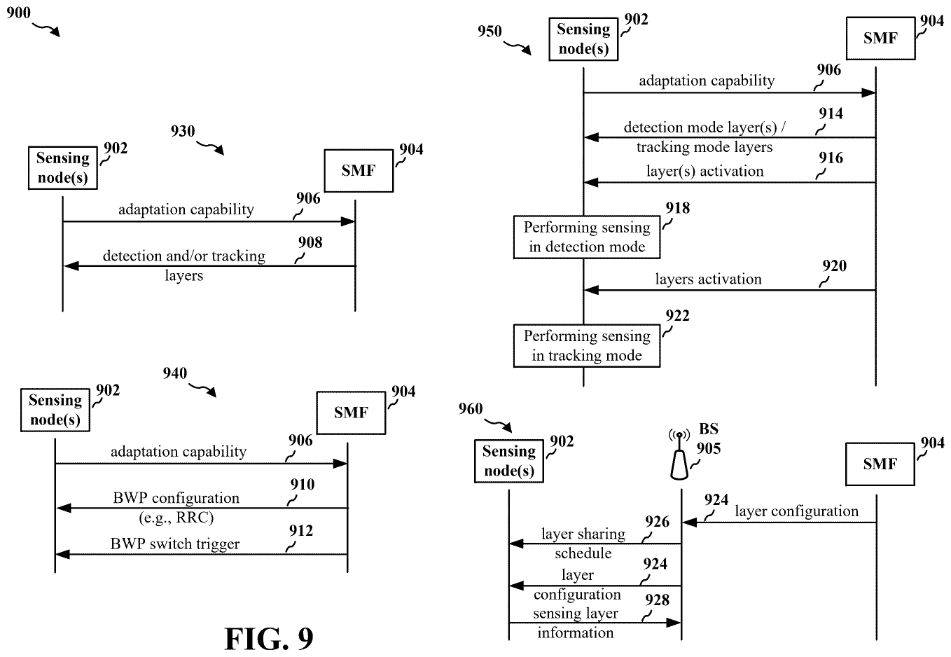

FIG. 9 shows call flow diagrams 900 for wireless communications, in various aspects. Call flow diagrams 900 may be further aspects of the call flow diagram 700 in FIG. 7 and/or the call flow diagram 800 in FIG. 8. Call flow diagrams 900 include a call flow 930, a call flow 940, a call flow 950, and a call flow 960.

For the call flow 930, a sensing node 902 communicates with a SMF 904. For example, the SMF 904 may configure the number of sensing layers to the sensing nodes based on different traffic/specifications. In aspects, a sensing node (e.g., the sensing node 902) may be a base station and/or a UE. The SMF 904 may receive an adaptation capability 906, e.g., as described above, and may configure the sensing node 902 with detection/tracking layers 908. That is, the SMF 904 may configure the sensing node 902 with the number of layers for the detection mode in sensing operations, e.g., a number a. The SMF 904 may also configure, based on the adaptation capability 906, the number of layers for the tracking mode in the sensing, e.g., a number B. Accordingly, the SMF 904 may directly configure the number of sensing layers for the detection/tracking mode.

For the call flow 940, the sensing node 902 communicates with the SMF 904. Aspects herein provide for defining sensing-layers dependent BWPs, where BWP switching leads to sensing layer adaptation, and one BWP may be associated to one specific number of sensing layers. For example, for a given BWP, the SMF 904 may receive the adaptation capability 906 from the sensing node 902 and configure the sensing node 902 with a BWP configuration 910 that includes number of layers for the detection mode (α), a number of layers for the tracking mode (β), or a pair of values (α, β) for both the detection and tracking modes. In aspects, the SMF 904 may configure the BWP(s) for the sensing modes via RRC signaling, and the BWP switching, as a BWP switch trigger 912 via DCI or medium access control (MAC) control element (MAC-CE), may trigger the associated number of layers for the sensing modes at the sensing node 902. For instance, the SMF 904 may configure the sensing node 902 with BWP information for the sensing via RRC signaling (e.g., {BWP1, α=1, β=4, others/etc.}, {BWP2, α=1, β=1, others/etc.}. The SMF 904 may activate the BWP1 for sensing, e.g., by DCI bits: {BWP1, α=1, 8=4, others/etc.}. Further, based on different traffic specifications for the sensing node 902, the SMF 904 may trigger the BWP switching, activating the BWP2 by DCI bits: {BWP2, α=1, β=1, others/etc.}.

For the call flow 950, the sensing node 902 communicates with the SMF 904. Aspects herein provide for the sensing mode (e.g., the detection/tracking modes) to be configured for the different purposes, where the mode may be switched to adapt different scenarios. Aspects provide for flexibility options in switching between the detection mode and the tracking mode for sensing operations. The SMF 904 may receive the adaptation capability 906 from the sensing node 902 and may configure the sensing node 902. As a first example, the configuring may be via DCI/MAC-CE/RRC signaling, and may directly enable the mode switching (e.g., as applied to the call flow 950). As a second example, mode dependent BWPs may be defined, where BWP switching leads to mode switching (e.g., as applied to the call flow 950).

As a third example, a specific number of sensing layers may be associated with the detection/tracking modes, and a layer configuration may trigger the corresponding sensing mode switching. For instance, the sensing node 902 may be configured with detection mode layer(s)/tracking mode layers 914 (also “layers 914”) by the SMF 904. In aspects, RRC signaling may configure a single layer for the detection mode and more than one layers for the tracking mode. through layers 914. When a single layer activation 916 is configured for sensing operations by the SMF 904, the sensing node 902 may switch (at 918) to the detection mode and perform sensing operations. If more than one layer is triggered via layer activation 920 (e.g., four layers) by the SMF 904, the sensing node 902 may switch (at 922) to the tracking mode and perform sensing operations.

For the call flow 960. a sensing node 902 communicates with a base station 905, which in turn communicates with the SMF 904. As noted herein, when layers sharing is enabled, the inter-layer interference may impact the sensing and communications. For example, in monostatic sensing, a base station/gNB may transmit four layers, with two layers for UE communication and two layers for sensing. Thus, four total layers are transmitted from the base station/gNB perspective, while two-layer RX is performed in the UE perspective for communication. That is, the UE may make the communication reception, and although such sensing layers may not impact the power savings at the UE side, active sensing layers may lead to interference and impact the reception of the communication layers in the UE side.

Thus, aspects provide that the tracking mode and the detection mode may be differentiated in this interference cancellation perspective. As shown, the base station 905 may receive a layer configuration 924 from the SMF 904, and provide a layer sharing schedule 926 to the sensing node 902. The base station 905 may then separately configure the sensing layer information to the scheduled UE (e.g., the layer configuration 924) in the communication layers. As an example, the layer configuration 924 may include one or more of: (1) an indication (e.g., 1 bit) to indicate if there is layer-sharing (e.g., for the sensing layers) associated with the sensing node 902, (2) a number of the sensing layers in the detection mode for the sensing node 902, (3) a number of the sensing layers in the tracking mode for the sensing node 902, and/or (4) a waveform for the tracking mode or the detection mode for the sensing node 902.

Additionally, as noted above, when monostatic sensing is enabled in the sensing node side, a sensing node may be configured to separately report/provide sensing layer information 928 to the Rx (e.g., a base station/gNB via Uu interface, a sidelink UE via sidelink signaling, etc.) in the communication layers. The sensing layer information includes the number of the sensing layers and waveform information, separately for detection/tracking modes.

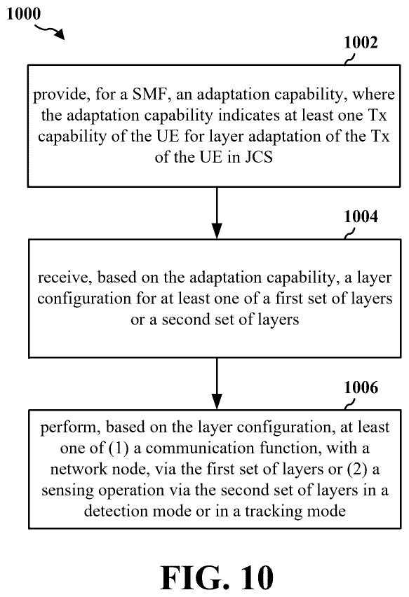

FIG. 10 is a flowchart 1000 of a method of wireless communication, in various aspects. The method may be performed by a sensing node (e.g., the sensing node 702, 902; the UE 104, 404, 602, 602′, 602″, 802, 802′; the apparatus 1404; the base station 102, 604, 805, 905; the network entity 1402, 1502). In some aspects, the method may include aspects described in connection with the communication flow in FIG. 7 and/or aspects described in FIGS. 8, 9. The method provides for multi-layers adaptation to enhance JCS performance that enables a UE to be configured by a network entity (e.g., a base station, SMF, etc.) with layer parameters for different implementations to trigger adaptive layers, for enhancements to signaling accuracy, signaling latency, and/or processing power usage/complexity, as well as for improvements in layer selection and utilization for types of sensing, specific cells, a BWP(s) for sensing, and/or the like, while minimizing inter-layer interference between the layers and allowing for less power to obtain desired SNRs/SINRs.

At 1002, the sensing node provides, for a SMF, an adaptation capability, where the adaptation capability indicates at least one Tx capability of the UE for layer adaptation of the Tx of the UE in JCS. As an example, the provision may be performed by the component 198. FIGS. 7-9 illustrate an example of a UE (e.g., the sensing node 702) providing such an adaptation capability for a network entity (e.g., the SMF 704).

The sensing node 702 may be configured to provide, for the SMF 704, an adaptation capability 706 (e.g., 806 in FIG. 8; 906 in FIG. 9). The adaptation capability 706 (e.g., 806 in FIG. 8; 906 in FIG. 9) may indicate at least one Tx capability of the sensing node 702 for layer adaptation of its Tx in JCS. In aspects, elements of the adaptation capability 706 (e.g., 806 in FIG. 8; 906 in FIG. 9) may include, but is not limited to, the following. A first indication (e.g., 1 bit) may be included to show whether the sensing node 702 supports MIMO-layers sharing in JCS for its Tx, e.g., a “layers_sharing_indication.” In the context of the aspects herein, MIMO-layers sharing may mean that some layers are triggered for sensing, and some layers are simultaneously enabled for communication. A second indication (e.g., M bits) may be included to indicate a maximum number of layers for sensing operations (e.g., 918, 922 in FIG. 9) when MIMO-layers sharing is enabled. A third indication (e.g., N1 bits) may be included to indicate a maximum number of layers for sensing operations (e.g., 918 in FIG. 9) in the detection mode. A fourth indication (e.g., N2 bits) may be included to indicate a maximum number of layers for sensing operations (e.g., 922 in FIG. 9) in the tracking mode.

In some aspects, the adaptation capability 706 (e.g., 806 in FIG. 8; 906 in FIG. 9) may indicate at least one Rx capability of the sensing node 702 (e.g., a UE) for the layer adaptation of the Rx for MIMO-layers sharing in the JCS. The MIMO-layers sharing in the JCS may be associated with at least one of communication layers or sensing layers. The Rx capability of the sensing node 702 for the layer adaptation of the Rx for the MIMO-layers sharing in the JCS associated with the communication layers may indicate at least one of a first indication of support for the communication layers when the sensing layers are simultaneously enabled and/or a second indication of support to handle inter-layer interference in the communication layers from the sensing layers. The Rx capability of the sensing node 702 for the layer adaptation of the Rx for the MIMO-layers sharing in the JCS associated with the sensing layers may indicate at least one of a first indication of support for the sensing layers when the communication layers are simultaneously enabled and/or a second indication of support to handle inter-layer interference in the sensing layers from the communication layers.

In aspects, the adaptation capability 706 (e.g., 806 in FIG. 8; 906 in FIG. 9) may be provided/reported to the SMF 704. Elements of the adaptation capability 706 (e.g., 806 in FIG. 8; 906 in FIG. 9) may be utilized by the network (e.g., the SMF 704) to schedule the sensing node 702 with resources for sensing and communications, to manage the interference among the sensing and communications, and/or as further described herein. For example, when a UE-centric monostatic sensing is considered, and MIMO-layers sharing is enabled, 3 layers (e.g., beams) may be enabled for sensing operations (e.g., 918, 922 in FIG. 9), and 2 layers (e.g., beams) may be enabled for communication, as shown for scenario 630 in FIG. 6, which is described above.

At 1004, the sensing node receive, based on the adaptation capability, a layer configuration for at least one of a first set of layers or a second set of layers. As an example, the reception may be performed by the component 198. FIGS. 7-9 illustrate an example of a UE (e.g., the sensing node 702) receiving such a layer configuration from a network entity (e.g., the SMF 704).

The SMF 704 may be configured to generate (at 708), based on the adaptation capability 706 (e.g., 806 in FIG. 8; 906 in FIG. 9) provided by the sensing node 702, a layer configuration 710 (e.g., 812 in FIG. 8; 924 in FIG. 9) for at least one of a first set of layers or a second set of layers. For example, based on the capability of the sensing node 702 for one or more of support for MIMO-layers sharing in JCS for its Tx, a maximum layers for sensing operations (e.g., 918, 922 in FIG. 9) when MIMO-layers sharing is enabled, a maximum layers for sensing operations (e.g., 918, 922 in FIG. 9) in the detection mode, and/or a maximum layers for sensing operations (e.g., 918, 922 in FIG. 9) in the tracking mode, the SMF 704 may generate (at 708) the layer configuration 710 (e.g., 812 in FIG. 8; 924 in FIG. 9). The SMF 704 may provide/transmit the layer configuration 710 (e.g., 812 in FIG. 8; 924 in FIG. 9) to the sensing node 702.

At 1006, the sensing node performs, based on the layer configuration, at least one of (1) a communication function, with a network node, via the first set of layers or (2) a sensing operation via the second set of layers in a detection mode or in a tracking mode. As an example, the performance may be performed by the component 198. FIGS. 7-9 illustrate an example of a UE (e.g., the sensing node 702) performing such communication/sensing operations.

The sensing node may be configured to perform (at 712), based on the layer configuration 710 (e.g., 812 in FIG. 8; 924 in FIG. 9), at least one of (1) a communication function, with a network node, via the first set of layers or (2) a sensing operation (e.g., 918, 922 in FIG. 9) via the second set of layers (e.g., 908, 914 in FIG. 9) in a detection mode or in a tracking mode. The sensing operation (e.g., 918, 922 in FIG. 9) may be a monostatic or bistatic (e.g., in association with a base station) sensing operation.

In aspects, for monostatic sensing operations, the sensing node 702 may be configured to provide/transmit sensing layer information (e.g., 928 in FIG. 9) associated with the monostatic sensing via at least one layer of the first set of layers. The sensing layer information (e.g., 928 in FIG. 9) may include at least one of a status indication of MIMO-layers sharing in the JCS for the sensing node 702, a first number of sensing layers associated with the detection mode, a second number of sensing layers associated with the tracking mode, and/or at least one waveform respectively associated with at least one of the detection mode or the tracking mode. Providing the sensing layer information (e.g., 928 in FIG. 9) may include providing the sensing layer information (e.g., 928 in FIG. 9) for at least one of (i) a network node via a UE-to-universal mobile telecommunications system (UMTS) terrestrial radio access network (UTRAN) (Uu) interface or (ii) another sensing node (e.g., a sidelink UE) via a sidelink connection. As noted herein, a base station and/or a sidelink UE may utilize the sensing layer information (e.g., 928 in FIG. 9) to adjust/improve multi-layer interference at the sensing node 702 and enhance sensing and communication performance, e.g., by using configured layer sharing parameters (e.g., 810, 812 in FIG. 8; 924, 926 in FIG. 9) for the sensing node 702.

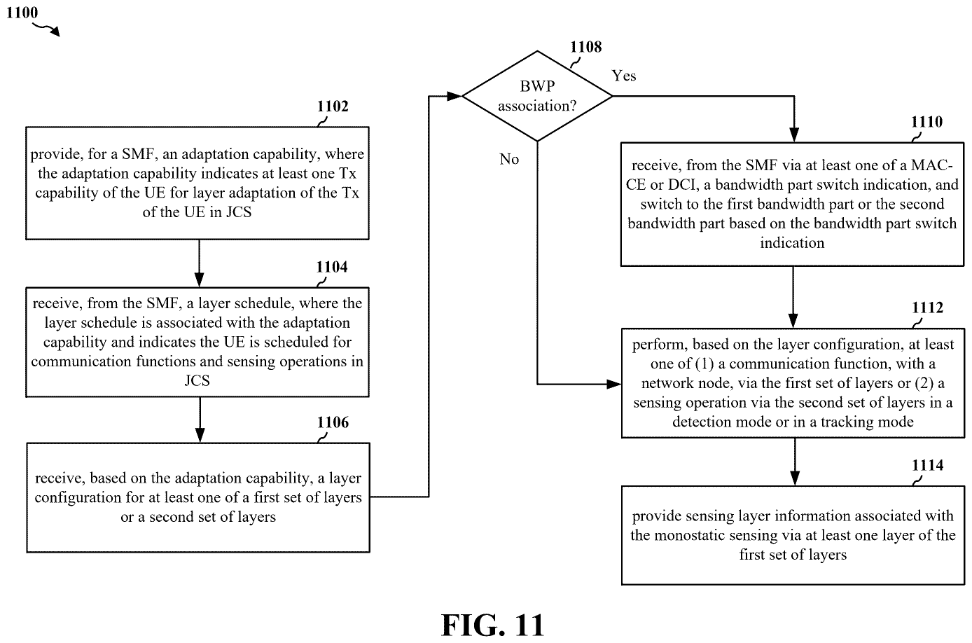

FIG. 11 is a flowchart 1100 of a method of wireless communication, in various aspects. The method may be performed by a sensing node (e.g., the sensing node 702, 902; the UE 104, 404, 602, 602′, 602″, 802, 802′; the apparatus 1404; the base station 102, 604, 805, 905; the network entity 1402, 1502). In some aspects, the method may include aspects described in connection with the communication flow in FIG. 7 and/or aspects described in FIGS. 8, 9. The method provides for multi-layers adaptation to enhance JCS performance that enables a UE to be configured by a network entity (e.g., a base station, SMF, etc.) with layer parameters for different implementations to trigger adaptive layers, for enhancements to signaling accuracy, signaling latency, and/or processing power usage/complexity, as well as for improvements in layer selection and utilization for types of sensing, specific cells, a BWP(s) for sensing, and/or the like, while minimizing inter-layer interference between the layers and allowing for less power to obtain desired SNRs/SINRs.

At 1102, the sensing node provides, for a SMF, an adaptation capability, where the adaptation capability indicates at least one Tx capability of the UE for layer adaptation of the Tx of the UE in JCS. As an example, the provision may be performed by the component 198. FIGS. 7-9 illustrate an example of a UE (e.g., the sensing node 702) providing such an adaptation capability for a network entity (e.g., the SMF 704).

The sensing node 702 may be configured to provide, for the SMF 704, an adaptation capability 706 (e.g., 806 in FIG. 8; 906 in FIG. 9). The adaptation capability 706 (e.g., 806 in FIG. 8; 906 in FIG. 9) may indicate at least one Tx capability of the sensing node 702 for layer adaptation of its Tx in JCS. In aspects, elements of the adaptation capability 706 (e.g., 806 in FIG. 8; 906 in FIG. 9) may include, but is not limited to, the following. A first indication (e.g., 1 bit) may be included to show whether the sensing node 702 supports MIMO-layers sharing in JCS for its Tx, e.g., a “layers_sharing_indication.” In the context of the aspects herein, MIMO-layers sharing may mean that some layers are triggered for sensing, and some layers are simultaneously enabled for communication. A second indication (e.g., M bits) may be included to indicate a maximum number of layers for sensing operations (e.g., 918, 922 in FIG. 9) when MIMO-layers sharing is enabled. A third indication (e.g., N1 bits) may be included to indicate a maximum number of layers for sensing operations (e.g., 918 in FIG. 9) in the detection mode. A fourth indication (e.g., N2 bits) may be included to indicate a maximum number of layers for sensing operations (e.g., 922 in FIG. 9) in the tracking mode.

In some aspects, the adaptation capability 706 (e.g., 806 in FIG. 8; 906 in FIG. 9) may indicate at least one Rx capability of the sensing node 702 (e.g., a UE) for the layer adaptation of the Rx for MIMO-layers sharing in the JCS. The MIMO-layers sharing in the JCS may be associated with at least one of communication layers or sensing layers. The Rx capability of the sensing node 702 for the layer adaptation of the Rx for the MIMO-layers sharing in the JCS associated with the communication layers may indicate at least one of a first indication of support for the communication layers when the sensing layers are simultaneously enabled and/or a second indication of support to handle inter-layer interference in the communication layers from the sensing layers. The Rx capability of the sensing node 702 for the layer adaptation of the Rx for the MIMO-layers sharing in the JCS associated with the sensing layers may indicate at least one of a first indication of support for the sensing layers when the communication layers are simultaneously enabled and/or a second indication of support to handle inter-layer interference in the sensing layers from the communication layers.

In aspects, the adaptation capability 706 (e.g., 806 in FIG. 8; 906 in FIG. 9) may be provided/reported to the SMF 704. Elements of the adaptation capability 706 (e.g., 806 in FIG. 8; 906 in FIG. 9) may be utilized by the network (e.g., the SMF 704) to schedule the sensing node 702 with resources for sensing and communications, to manage the interference among the sensing and communications, and/or as further described herein. For example, when a UE-centric monostatic sensing is considered, and MIMO-layers sharing is enabled, 3 layers (e.g., beams) may be enabled for sensing operations (e.g., 918, 922 in FIG. 9), and 2 layers (e.g., beams) may be enabled for communication, as shown for scenario 630 in FIG. 6, which is described above.

At 1104, the sensing node receives, from the SMF, a layer schedule, where the layer schedule is associated with the adaptation capability and indicates the UE is scheduled for communication functions and sensing operations in JCS. As an example, the reception may be performed by the component 198. FIGS. 8, 9 illustrate an example of a UE (e.g., the sensing node 702) receiving such a layer schedule from a network entity (e.g., the SMF 704).

The sensing node 702 may be configured to receive a layer sharing schedule (e.g., 810, 812 in FIG. 8; 924, 926 in FIG. 9) from the SMF 704 (and/or, e.g., the base station 805 in FIG. 8, 905 in FIG. 9). As noted herein, when layers sharing is enabled, the inter-layer interference may impact the sensing and communications. For example, in monostatic sensing, a base station/gNB may transmit four layers, with two layers for UE communication and two layers for sensing. Thus, four total layers are transmitted from the base station/gNB perspective, while two-layer RX is performed in the UE perspective for communication. That is, the UE may make the communication reception, and although such sensing layers may not impact the power savings at the UE side, active sensing layers may lead to interference and impact the reception of the communication layers in the UE side. Thus, aspects provide that the tracking mode and the detection mode may be differentiated in this interference cancellation perspective.

At 1106, the sensing node receives, based on the adaptation capability, a layer configuration for at least one of a first set of layers or a second set of layers. As an example, the reception may be performed by the component 198. FIGS. 7-9 illustrate an example of a UE (e.g., the sensing node 702) receiving such a layer configuration from a network entity (e.g., the SMF 704).

A base station (e.g., the base station 905 in FIG. 9) may receive a layer configuration 924 from the SMF 704 (e.g., 904 in FIG. 9), and provide a layer sharing schedule 926 to the sensing node 702 (e.g., 902 in FIG. 9). The base station may then separately configure the sensing layer information to the scheduled UE (e.g., the layer configuration 924) in the communication layers. As an example, the layer configuration 924 may include one or more of: (1) an indication (e.g., 1 bit) to indicate if there is layer-sharing (e.g., for the sensing layers) associated with the sensing node 902, (2) a number of the sensing layers in the detection mode for the sensing node 902, (3) a number of the sensing layers in the tracking mode for the sensing node 902, and/or (4) a waveform for the tracking mode or the detection mode for the sensing node 902. Additionally, as noted above, when monostatic sensing is enabled in the sensing node side, a sensing node may be configured to separately report/provide sensing layer information 928 to the Rx (e.g., a base station/gNB via Uu interface, a sidelink UE via sidelink signaling, etc.) in the communication layers. The sensing layer information includes the number of the sensing layers and waveform information, separately for detection/tracking modes.

At 1108, it is determined if BWP association is configured. As an example, the determination may be performed by the component 198. If so, flowchart 1100 continues to 1110; if not, flowchart 1100 continues to 1112.

At 1110, the sensing node receives, from the SMF via at least one of a MAC-CE or DCI, a bandwidth part (BWP) switch indication, and switches to the first bandwidth part or the second bandwidth part based on the bandwidth part switch indication. As an example, the reception and switch may be performed by the component 198. FIG. 9 illustrates an example of a UE (e.g., the sensing node 702) receiving such a BWP switch indication from a network entity (e.g., the SMF 704) and switching between BWPs.

The sensing node 702 (e.g., 902 of call flow 940 in FIG. 9) may communicate with the SMF 704 (e.g., 904 of call flow 940 in FIG. 9). As illustrative, with respect to FIG. 9, for the call flow 940, the sensing node 902 communicates with the SMF 904. Aspects herein provide for defining sensing-layers dependent BWPs, where BWP switching leads to sensing layer adaptation, and one BWP may be associated to one specific number of sensing layers. For example, for a given BWP, the SMF 904 may receive the adaptation capability 906 from the sensing node 902 and configure the sensing node 902 with a BWP configuration 910 that includes number of layers for the detection mode (α), a number of layers for the tracking mode (β), or a pair of values (α, B) for both the detection and tracking modes. In aspects, the SMF 904 may configure the BWP(s) for the sensing modes via RRC signaling, and the BWP switching, as a BWP switch trigger 912 via DCI or medium access control (MAC) control element (MAC-CE), may trigger the associated number of layers for the sensing modes at the sensing node 902. For instance, the SMF 904 may configure the sensing node 902 with BWP information for the sensing via RRC signaling (e.g., {BWP1, α=1, β=4, others/etc.}, {BWP2, α=1, β=1, others/etc.}. The SMF 904 may activate the BWP1 for sensing, e.g., by DCI bits: {BWP1, α=1, 8=4, others/etc.}. Further, based on different traffic specifications for the sensing node 902, the SMF 904 may trigger the BWP switching, activating the BWP2 by DCI bits: {BWP2, α=1, β=1, others/etc.}.

At 1112, the sensing node performs, based on the layer configuration, at least one of (1) a communication function, with a network node, via the first set of layers or (2) a sensing operation via the second set of layers in a detection mode or in a tracking mode. As an example, the performance may be performed by the component 198. FIGS. 7-9 illustrate an example of a UE (e.g., the sensing node 702) performing such communication/sensing operations.

The sensing node may be configured to perform (at 712), based on the layer configuration 710 (e.g., 812 in FIG. 8; 924 in FIG. 9), at least one of (1) a communication function, with a network node, via the first set of layers or (2) a sensing operation (e.g., 918, 922 in FIG. 9) via the second set of layers (e.g., 908, 914 in FIG. 9) in a detection mode or in a tracking mode. The sensing operation (e.g., 918, 922 in FIG. 9) may be a monostatic or bistatic (e.g., in association with a base station) sensing operation.

At 1114, the sensing node provides sensing layer information associated with the monostatic sensing via at least one layer of the first set of layers. As an example, the provision may be performed by the component 198. FIG. 9 illustrates an example of a UE (e.g., the sensing node 702) providing such sensing layer information for a network entity (e.g., the base station 905).

For monostatic sensing operations, the sensing node 702 may be configured to provide/transmit for or to the SMF 704 sensing layer information (e.g., 928 in FIG. 9) associated with the monostatic sensing via at least one layer of the first set of layers. The sensing layer information (e.g., 928 in FIG. 9) may include at least one of a status indication of MIMO-layers sharing in the JCS for the sensing node 702, a first number of sensing layers associated with the detection mode, a second number of sensing layers associated with the tracking mode, and/or at least one waveform respectively associated with at least one of the detection mode or the tracking mode. Providing the sensing layer information (e.g., 928 in FIG. 9) may include providing the sensing layer information (e.g., 928 in FIG. 9) for at least one of (i) a network node via a UE-to-universal mobile telecommunications system (UMTS) terrestrial radio access network (UTRAN) (Uu) interface or (ii) another sensing node (e.g., a sidelink UE) via a sidelink connection. As noted herein, a base station and/or a sidelink UE may utilize the sensing layer information (e.g., 928 in FIG. 9) to adjust/improve multi-layer interference at the sensing node 702 and enhance sensing and communication performance, e.g., by using configured layer sharing parameters (e.g., 810, 812 in FIG. 8; 924, 926 in FIG. 9) for the sensing node 702.

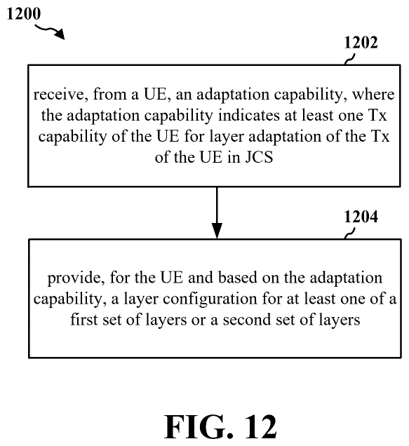

FIG. 12 is a flowchart 1200 of a method of wireless communication, in various aspects. The method may be performed by a sensing entity (e.g., the SMF 704, 804, 904; the base station 102, 604, 805, 905; the network entity 1402, 1502, 1660). In some aspects, the method may include aspects described in connection with the communication flow in FIG. 7 and/or aspects described in FIGS. 8, 9. The method provides for multi-layers adaptation to enhance JCS performance that enables a UE to be configured by a network entity (e.g., a base station, SMF, etc.) with layer parameters for different implementations to trigger adaptive layers, for enhancements to signaling accuracy, signaling latency, and/or processing power usage/complexity, as well as for improvements in layer selection and utilization for types of sensing, specific cells, a BWP(s) for sensing, and/or the like, while minimizing inter-layer interference between the layers and allowing for less power to obtain desired SNRs/SINRs.

At 1202, the sensing entity receives, from a UE, an adaptation capability, where the adaptation capability indicates at least one Tx capability of the UE for layer adaptation of the Tx of the UE in JCS. As an example, the reception may be performed by the component 199. FIGS. 7-9 illustrate an example of the SMF 704 receiving such an adaptation capability from a UE (e.g., the sensing node 702).

The sensing node 702 may be configured to provide, for the SMF 704 to receive, an adaptation capability 706 (e.g., 806 in FIG. 8; 906 in FIG. 9). The adaptation capability 706 (e.g., 806 in FIG. 8; 906 in FIG. 9) may indicate at least one Tx capability of the sensing node 702 for layer adaptation of its Tx in JCS. In aspects, elements of the adaptation capability 706 (e.g., 806 in FIG. 8; 906 in FIG. 9) may include, but is not limited to, the following. A first indication (e.g., 1 bit) may be included to show whether the sensing node 702 supports MIMO-layers sharing in JCS for its Tx, e.g., a “layers_sharing_indication.” In the context of the aspects herein, MIMO-layers sharing may mean that some layers are triggered for sensing, and some layers are simultaneously enabled for communication. A second indication (e.g., M bits) may be included to indicate a maximum number of layers for sensing operations (e.g., 918, 922 in FIG. 9) when MIMO-layers sharing is enabled. A third indication (e.g., N1 bits) may be included to indicate a maximum number of layers for sensing operations (e.g., 918 in FIG. 9) in the detection mode. A fourth indication (e.g., N2 bits) may be included to indicate a maximum number of layers for sensing operations (e.g., 922 in FIG. 9) in the tracking mode.

In some aspects, the adaptation capability 706 (e.g., 806 in FIG. 8; 906 in FIG. 9) may indicate at least one Rx capability of the sensing node 702 (e.g., a UE) for the layer adaptation of the Rx for MIMO-layers sharing in the JCS. The MIMO-layers sharing in the JCS may be associated with at least one of communication layers or sensing layers. The Rx capability of the sensing node 702 for the layer adaptation of the Rx for the MIMO-layers sharing in the JCS associated with the communication layers may indicate at least one of a first indication of support for the communication layers when the sensing layers are simultaneously enabled and/or a second indication of support to handle inter-layer interference in the communication layers from the sensing layers. The Rx capability of the sensing node 702 for the layer adaptation of the Rx for the MIMO-layers sharing in the JCS associated with the sensing layers may indicate at least one of a first indication of support for the sensing layers when the communication layers are simultaneously enabled and/or a second indication of support to handle inter-layer interference in the sensing layers from the communication layers.

In aspects, the adaptation capability 706 (e.g., 806 in FIG. 8; 906 in FIG. 9) may be provided/reported to the SMF 704. Elements of the adaptation capability 706 (e.g., 806 in FIG. 8; 906 in FIG. 9) may be utilized by the network (e.g., the SMF 704) to schedule the sensing node 702 with resources for sensing and communications, to manage the interference among the sensing and communications, and/or as further described herein. For example, when a UE-centric monostatic sensing is considered, and MIMO-layers sharing is enabled, 3 layers (e.g., beams) may be enabled for sensing operations (e.g., 918, 922 in FIG. 9), and 2 layers (e.g., beams) may be enabled for communication, as shown for scenario 630 in FIG. 6, which is described above.

At 1204, the sensing entity provides, for the UE and based on the adaptation capability, a layer configuration for at least one of a first set of layers or a second set of layers. As an example, the provision may be performed by the component 199. FIGS. 7-9 illustrate an example of the SMF 704 providing such a layer configuration for a UE (e.g., the sensing node 702).

The SMF 704 may be configured to generate (at 708), based on the adaptation capability 706 (e.g., 806 in FIG. 8; 906 in FIG. 9) provided by the sensing node 702, a layer configuration 710 (e.g., 812 in FIG. 8; 924 in FIG. 9) for at least one of a first set of layers or a second set of layers. For example, based on the capability of the sensing node 702 for one or more of support for MIMO-layers sharing in JCS for its Tx, a maximum layers for sensing operations (e.g., 918, 922 in FIG. 9) when MIMO-layers sharing is enabled, a maximum layers for sensing operations (e.g., 918, 922 in FIG. 9) in the detection mode, and/or a maximum layers for sensing operations (e.g., 918, 922 in FIG. 9) in the tracking mode, the SMF 704 may generate (at 708) the layer configuration 710 (e.g., 812 in FIG. 8; 924 in FIG. 9). The SMF 704 may provide/transmit the layer configuration 710 (e.g., 812 in FIG. 8; 924 in FIG. 9) to the sensing node 702.

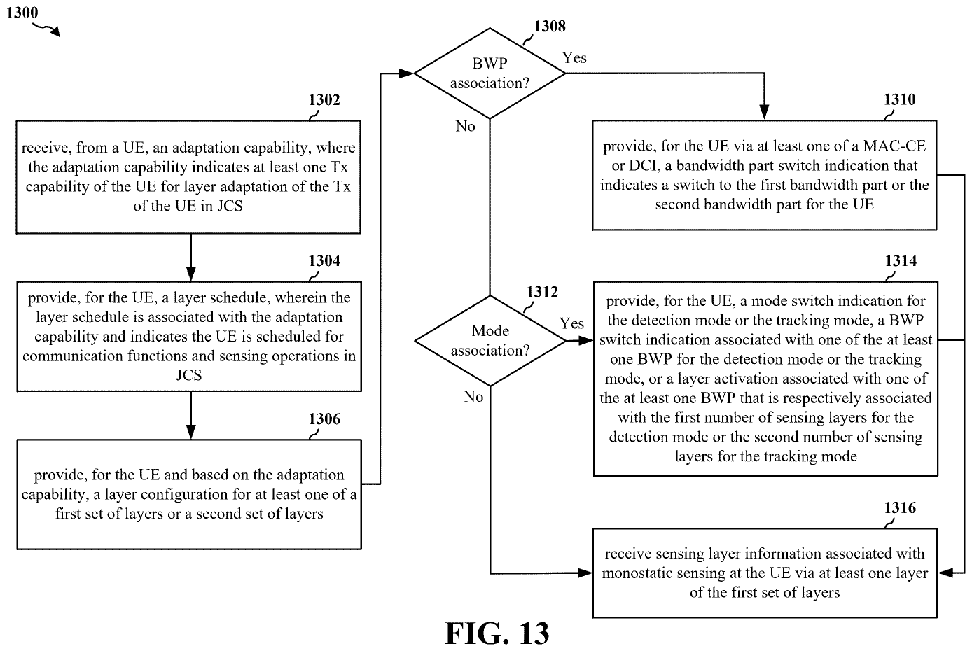

FIG. 13 is a flowchart 1300 of a method of wireless communication, in various aspects. The method may be performed by a sensing entity (e.g., the SMF 704, 804, 904; the base station 102, 604, 805, 905; the network entity 1402, 1502, 1660). In some aspects, the method may include aspects described in connection with the communication flow in FIG. 7 and/or aspects described in FIGS. 8, 9. The method provides for multi-layers adaptation to enhance JCS performance that enables a UE to be configured by a network entity (e.g., a base station, SMF, etc.) with layer parameters for different implementations to trigger adaptive layers, for enhancements to signaling accuracy, signaling latency, and/or processing power usage/complexity, as well as for improvements in layer selection and utilization for types of sensing, specific cells, a BWP(s) for sensing, and/or the like, while minimizing inter-layer interference between the layers and allowing for less power to obtain desired SNRs/SINRs.

At 1302, the sensing entity receives, from a UE, an adaptation capability, where the adaptation capability indicates at least one Tx capability of the UE for layer adaptation of the Tx of the UE in JCS. As an example, the reception may be performed by the component 199. FIGS. 7-9 illustrate an example of the SMF 704 receiving such an adaptation capability from a UE (e.g., the sensing node 702).

The sensing node 702 may be configured to provide, for the SMF 704, an adaptation capability 706 (e.g., 806 in FIG. 8; 906 in FIG. 9). The adaptation capability 706 (e.g., 806 in FIG. 8; 906 in FIG. 9) may indicate at least one Tx capability of the sensing node 702 for layer adaptation of its Tx in JCS. In aspects, elements of the adaptation capability 706 (e.g., 806 in FIG. 8; 906 in FIG. 9) may include, but is not limited to, the following. A first indication (e.g., 1 bit) may be included to show whether the sensing node 702 supports MIMO-layers sharing in JCS for its Tx, e.g., a “layers_sharing_indication.” In the context of the aspects herein, MIMO-layers sharing may mean that some layers are triggered for sensing, and some layers are simultaneously enabled for communication. A second indication (e.g., M bits) may be included to indicate a maximum number of layers for sensing operations (e.g., 918, 922 in FIG. 9) when MIMO-layers sharing is enabled. A third indication (e.g., N1 bits) may be included to indicate a maximum number of layers for sensing operations (e.g., 918 in FIG. 9) in the detection mode. A fourth indication (e.g., N2 bits) may be included to indicate a maximum number of layers for sensing operations (e.g., 922 in FIG. 9) in the tracking mode.

In some aspects, the adaptation capability 706 (e.g., 806 in FIG. 8; 906 in FIG. 9) may indicate at least one Rx capability of the sensing node 702 (e.g., a UE) for the layer adaptation of the Rx for MIMO-layers sharing in the JCS. The MIMO-layers sharing in the JCS may be associated with at least one of communication layers or sensing layers. The Rx capability of the sensing node 702 for the layer adaptation of the Rx for the MIMO-layers sharing in the JCS associated with the communication layers may indicate at least one of a first indication of support for the communication layers when the sensing layers are simultaneously enabled and/or a second indication of support to handle inter-layer interference in the communication layers from the sensing layers. The Rx capability of the sensing node 702 for the layer adaptation of the Rx for the MIMO-layers sharing in the JCS associated with the sensing layers may indicate at least one of a first indication of support for the sensing layers when the communication layers are simultaneously enabled and/or a second indication of support to handle inter-layer interference in the sensing layers from the communication layers.

In aspects, the adaptation capability 706 (e.g., 806 in FIG. 8; 906 in FIG. 9) may be provided/reported to the SMF 704. Elements of the adaptation capability 706 (e.g., 806 in FIG. 8; 906 in FIG. 9) may be utilized by the network (e.g., the SMF 704) to schedule the sensing node 702 with resources for sensing and communications, to manage the interference among the sensing and communications, and/or as further described herein. For example, when a UE-centric monostatic sensing is considered, and MIMO-layers sharing is enabled, 3 layers (e.g., beams) may be enabled for sensing operations (e.g., 918, 922 in FIG. 9), and 2 layers (e.g., beams) may be enabled for communication, as shown for scenario 630 in FIG. 6, which is described above.

At 1304, the sensing entity provides, for the UE, a layer schedule, where the layer schedule is associated with the adaptation capability and indicates the UE is scheduled for communication functions and sensing operations in JCS. As an example, the provision may be performed by the component 199. FIGS. 8, 9 illustrate an example of the SMF 704 providing such a layer schedule for a UE (e.g., the sensing node 702).

The sensing node 702 may be configured to receive a layer sharing schedule (e.g., 810, 812 in FIG. 8; 924, 926 in FIG. 9) provided from the SMF 704 (and/or, a base station (e.g., 805 in FIG. 8, 905 in FIG. 9)). As noted herein, when layers sharing is enabled, the inter-layer interference may impact the sensing and communications. For example, in monostatic sensing, a base station/gNB may transmit four layers, with two layers for UE communication and two layers for sensing. Thus, four total layers are transmitted from the base station/gNB perspective, while two-layer RX is performed in the UE perspective for communication. That is, the UE may make the communication reception, and although such sensing layers may not impact the power savings at the UE side, active sensing layers may lead to interference and impact the reception of the communication layers in the UE side. Thus, aspects provide that the tracking mode and the detection mode may be differentiated in this interference cancellation perspective.

At 1306, the sensing entity provides, for the UE and based on the adaptation capability, a layer configuration for at least one of a first set of layers or a second set of layers. As an example, the provision may be performed by the component 199. FIGS. 7-9 illustrate an example of the SMF 704 providing such a layer configuration for a UE (e.g., the sensing node 702).

A base station (e.g., the base station 905 in FIG. 9) may receive a layer configuration 924 from the SMF 704 (e.g., 904 in FIG. 9), and provide a layer sharing schedule 926 to the sensing node 702 (e.g., 902 in FIG. 9). The base station may then separately configure the sensing layer information to the scheduled UE (e.g., the layer configuration 924) in the communication layers. As an example, the layer configuration 924 may include one or more of: (1) an indication (e.g., 1 bit) to indicate if there is layer-sharing (e.g., for the sensing layers) associated with the sensing node 902, (2) a number of the sensing layers in the detection mode for the sensing node 902, (3) a number of the sensing layers in the tracking mode for the sensing node 902, and/or (4) a waveform for the tracking mode or the detection mode for the sensing node 902. Additionally, as noted above, when monostatic sensing is enabled in the sensing node side, a sensing node may be configured to separately report/provide sensing layer information 928 to the Rx (e.g., a base station/gNB via Uu interface, a sidelink UE via sidelink signaling, etc.) in the communication layers. The sensing layer information includes the number of the sensing layers and waveform information, separately for detection/tracking modes.

At 1308, it is determined if BWP association is configured. As an example, the performance may be performed by the component 199. If so, flowchart 1300 continues to 1310; if not, flowchart 1300 continues to 1312.

At 1310, the sensing entity provides, for the UE via at least one of a MAC-CE or DCI, a bandwidth part switch indication that indicates a switch to the first bandwidth part or the second bandwidth part for the UE. As an example, the provision may be performed by the component 199. FIG. 9 illustrates an example of the SMF 704 providing such a BWP switch indication for a UE (e.g., the sensing node 702).

The sensing node 702 (e.g., 902 of call flow 940 in FIG. 9) may communicate with the SMF 704 (e.g., 904 of call flow 940 in FIG. 9). As illustrative, with respect to FIG. 9, for the call flow 940, the sensing node 902 communicates with the SMF 904. Aspects herein provide for defining sensing-layers dependent BWPs, where BWP switching leads to sensing layer adaptation, and one BWP may be associated to one specific number of sensing layers. For example, for a given BWP, the SMF 904 may receive the adaptation capability 906 from the sensing node 902 and configure the sensing node 902 with a BWP configuration 910 that includes number of layers for the detection mode (α), a number of layers for the tracking mode (β), or a pair of values (α, B) for both the detection and tracking modes. In aspects, the SMF 904 may configure the BWP(s) for the sensing modes via RRC signaling, and the BWP switching, as a BWP switch trigger 912 via DCI or medium access control (MAC) control element (MAC-CE), may trigger the associated number of layers for the sensing modes at the sensing node 902. For instance, the SMF 904 may configure the sensing node 902 with BWP information for the sensing via RRC signaling (e.g., {BWP1, α=1, β=4, others/etc.}, {BWP2, α=1, β=1, others/etc.}. The SMF 904 may activate the BWP1 for sensing, e.g., by DCI bits: {BWP1, α=1, β=4, others/etc.}. Further, based on different traffic specifications for the sensing node 902, the SMF 904 may trigger the BWP switching, activating the BWP2 by DCI bits: {BWP2, α=1, β=1, others/etc.}.

At 1312, it is determined if mode association is configured. As an example, the determination may be performed by the component 199. If so, flowchart 1300 continues to 1314; if not, flowchart 1300 continues to 1316.

At 1314, the sensing entity provides, for the UE, a mode switch indication for the detection mode or the tracking mode, a BWP switch indication associated with one of the at least one BWP for the detection mode or the tracking mode, or a layer activation associated with one of the at least one BWP that is respectively associated with the first number of sensing layers for the detection mode or the second number of sensing layers for the tracking mode. As an example, the provision may be performed by the component 199. FIG. 9 illustrates an example of the SMF 704 providing such mode indications for a UE (e.g., the sensing node 702).

The sensing node 702 (e.g., 902 of call flow 950 in FIG. 9) may communicate with the SMF 704 (e.g., 904 of call flow 950 in FIG. 9). As illustrative, with respect to FIG. 9, for the call flow 950, the sensing node 902 communicates with the SMF 904. Aspects herein provide for the sensing mode (e.g., the detection/tracking modes) to be configured for the different purposes, where the mode may be switched to adapt different scenarios. Aspects provide for flexibility options in switching between the detection mode and the tracking mode for sensing operations. The SMF 904 may receive the adaptation capability 906 from the sensing node 902 and may configure the sensing node 902. As a first example, the configuring may be via DCI/MAC-CE/RRC signaling, and may directly enable the mode switching (e.g., as applied to the call flow 950). As a second example, mode dependent BWPs may be defined, where BWP switching leads to mode switching (e.g., as applied to the call flow 950). As a third example, a specific number of sensing layers may be associated with the detection/tracking modes, and a layer configuration may trigger the corresponding sensing mode switching. For instance, the sensing node 902 may be configured with detection mode layer(s)/tracking mode layers 914 (also “layers 914”) by the SMF 904. In aspects, RRC signaling may configure a single layer for the detection mode and more than one layers for the tracking mode. through layers 914. When a single layer activation 916 is configured for sensing operations by the SMF 904, the sensing node 902 may switch (at 918) to the detection mode and perform sensing operations. If more than one layer is triggered via layer activation 920 (e.g., four layers) by the SMF 904, the sensing node 902 may switch (at 922) to the tracking mode and perform sensing operations.

At 1316, the sensing entity receives sensing layer information associated with monostatic sensing at the UE via at least one layer of the first set of layers. As an example, the reception may be performed by the component 199. FIG. 9 illustrates an example of the base station 905 receiving such information from a UE (e.g., the sensing node 702).

For monostatic sensing operations, the sensing node 702 may be configured to provide/transmit for or to the SMF 704 sensing layer information (e.g., 928 in FIG. 9) associated with the monostatic sensing via at least one layer of the first set of layers. The sensing layer information (e.g., 928 in FIG. 9) may include at least one of a status indication of MIMO-layers sharing in the JCS for the sensing node 702, a first number of sensing layers associated with the detection mode, a second number of sensing layers associated with the tracking mode, and/or at least one waveform respectively associated with at least one of the detection mode or the tracking mode. Providing the sensing layer information (e.g., 928 in FIG. 9) may include providing the sensing layer information (e.g., 928 in FIG. 9) for at least one of (i) a network node via a UE-to-universal mobile telecommunications system (UMTS) terrestrial radio access network (UTRAN) (Uu) interface or (ii) another sensing node (e.g., a sidelink UE) via a sidelink connection. As noted herein, a base station and/or a sidelink UE may utilize the sensing layer information (e.g., 928 in FIG. 9) to adjust/improve multi-layer interference at the sensing node 702 and enhance sensing and communication performance, e.g., by using configured layer sharing parameters (e.g., 810, 812 in FIG. 8; 924, 926 in FIG. 9) for the sensing node 702.

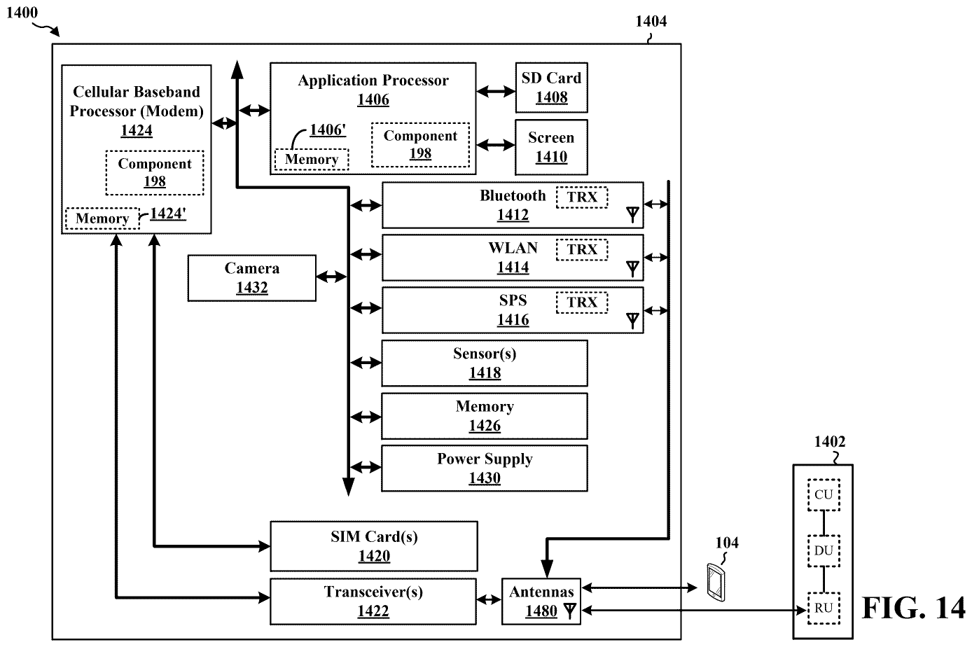

FIG. 14 is a diagram 1400 illustrating an example of a hardware implementation for an apparatus 1404. The apparatus 1404 may be a UE, a component of a UE, or may implement UE functionality. In some aspects, the apparatus 1404 may include a cellular baseband processor 1424 (also referred to as a modem) coupled to one or more transceivers 1422 (e.g., cellular RF transceiver). The cellular baseband processor 1424 may include on-chip memory 1424′. In some aspects, the apparatus 1404 may further include one or more subscriber identity modules (SIM) cards 1420 and an application processor 1406 coupled to a secure digital (SD) card 1408 and a screen 1410. The application processor 1406 may include on-chip memory 1406′. In some aspects, the apparatus 1404 may further include a Bluetooth module 1412, a WLAN module 1414, an SPS module 1416 (e.g., GNSS module), one or more sensor modules 1418 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1426, a power supply 1430, and/or a camera 1432. The Bluetooth module 1412, the WLAN module 1414, and the SPS module 1416 may include an on-chip transceiver (TRX) (or in some cases, just a receiver (RX)). The Bluetooth module 1412, the WLAN module 1414, and the SPS module 1416 may include their own dedicated antennas and/or utilize the antennas 1480 for communication. The cellular baseband processor 1424 communicates through the transceiver(s) 1422 via one or more antennas 1480 with the UE 104 and/or with an RU associated with a network entity 1402. The cellular baseband processor 1424 and the application processor 1406 may each include a computer-readable medium/memory 1424′, 1406′, respectively. The additional memory modules 1426 may also be considered a computer-readable medium/memory. Each computer-readable medium/memory 1424′, 1406′, 1426 may be non-transitory. The cellular baseband processor 1424 and the application processor 1406 are each responsible for general processing, including the execution of software stored on the computer-readable medium/memory. The software, when executed by the cellular baseband processor 1424/application processor 1406, causes the cellular baseband processor 1424/application processor 1406 to perform the various functions described supra. The computer-readable medium/memory may also be used for storing data that is manipulated by the cellular baseband processor 1424/application processor 1406 when executing software. The cellular baseband processor 1424/application processor 1406 may be a component of the UE 350 and may include the memory 360 and/or at least one of the TX processor 368, the RX processor 356, and the controller/processor 359. In one configuration, the apparatus 1404 may be a processor chip (modem and/or application) and include just the cellular baseband processor 1424 and/or the application processor 1406, and in another configuration, the apparatus 1404 may be the entire UE (e.g., see UE 350 of FIG. 3) and include the additional modules of the apparatus 1404.

As discussed supra, the component 198 may be configured to provide, for a SMF, an adaptation capability, where the adaptation capability indicates at least one Tx capability of the UE for layer adaptation of the Tx of the UE in JCS. The component 198 may also be configured to receive, based on the adaptation capability, a layer configuration for at least one of a first set of layers or a second set of layers. The component 198 may be further configured to perform, based on the layer configuration, at least one of (1) a communication function, with a network node, via the first set of layers or (2) a sensing operation via the second set of layers in a detection mode or in a tracking mode. The component 198 may be configured to receive, from the SMF, a layer schedule, where the layer schedule is associated with the adaptation capability and indicates the UE is scheduled for communication functions and sensing operations in JCS. The component 198 may be configured to receive, from the SMF via at least one of a MAC-CE or DCI, a bandwidth part switch indication, and to switch to the first bandwidth part or the second bandwidth part based on the bandwidth part switch indication. The component 198 may be configured to provide sensing layer information associated with the monostatic sensing via at least one layer of the first set of layers. The component 198 may be further configured to perform any of the aspects described in connection with the flowchart in any of FIGS. 10, 11, 12, 13 and/or any of the aspects performed by a UE in association with any of FIGS. 6-9. The component 198 may be within the cellular baseband processor 1424, the application processor 1406, or both the cellular baseband processor 1424 and the application processor 1406. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1404 may include a variety of components configured for various functions. In one configuration, the apparatus 1404, and in particular the cellular baseband processor 1424 and/or the application processor 1406, may include means for providing, for a SMF, an adaptation capability, where the adaptation capability indicates at least one Tx capability of the UE for layer adaptation of the Tx of the UE in JCS. In one configuration, the apparatus 1404, and in particular the cellular baseband processor 1424 and/or the application processor 1406, may include means for receiving, based on the adaptation capability, a layer configuration for at least one of a first set of layers or a second set of layers. In one configuration, the apparatus 1404, and in particular the cellular baseband processor 1424 and/or the application processor 1406, may include means for performing, based on the layer configuration, at least one of (1) a communication function, with a network node, via the first set of layers or (2) a sensing operation via the second set of layers in a detection mode or in a tracking mode. In one configuration, the apparatus 1404, and in particular the cellular baseband processor 1424 and/or the application processor 1406, may include means for receiving, from the SMF, a layer schedule, where the layer schedule is associated with the adaptation capability and indicates the UE is scheduled for communication functions and sensing operations in JCS. In one configuration, the apparatus 1404, and in particular the cellular baseband processor 1424 and/or the application processor 1406, may include means for receiving, from the SMF via at least one of a MAC-CE or DCI, a bandwidth part switch indication, and means for switching to the first bandwidth part or the second bandwidth part based on the bandwidth part switch indication. In one configuration, the apparatus 1404, and in particular the cellular baseband processor 1424 and/or the application processor 1406, may include means for providing sensing layer information associated with the monostatic sensing via at least one layer of the first set of layers. The means may be the component 198 of the apparatus 1404 configured to perform the functions recited by the means. As described supra, the apparatus 1404 may include the TX processor 368, the RX processor 356, and the controller/processor 359. As such, in one configuration, the means may be the TX processor 368, the RX processor 356, and/or the controller/processor 359 configured to perform the functions recited by the means.

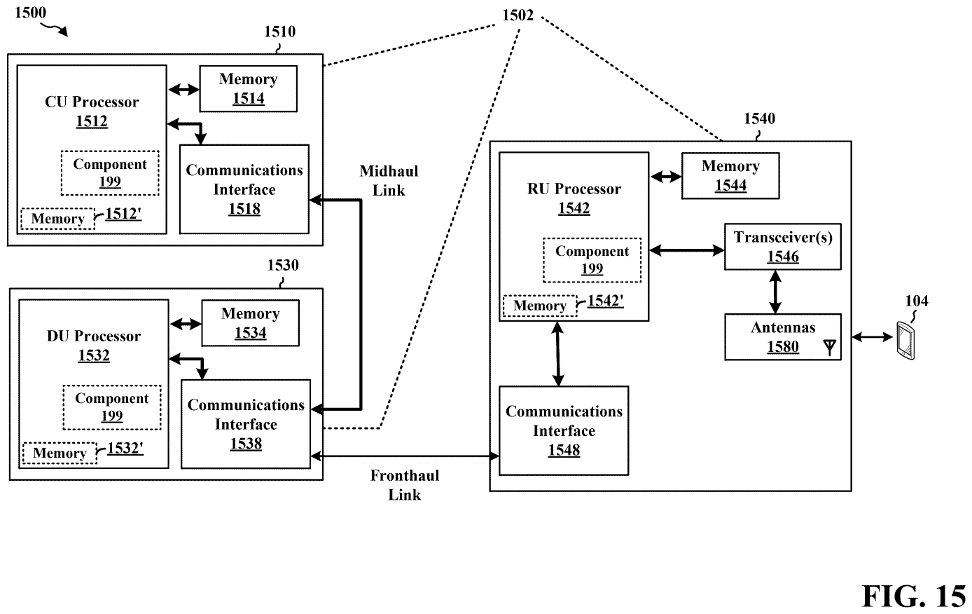

FIG. 15 is a diagram 1500 illustrating an example of a hardware implementation for a network entity 1502. The network entity 1502 may be a BS, a component of a BS, or may implement BS functionality. The network entity 1502 may include at least one of a CU 1510, a DU 1530, or an RU 1540. For example, depending on the layer functionality handled by the component 199, the network entity 1502 may include the CU 1510; both the CU 1510 and the DU 1530; each of the CU 1510, the DU 1530, and the RU 1540; the DU 1530; both the DU 1530 and the RU 1540; or the RU 1540. The CU 1510 may include a CU processor 1512. The CU processor 1512 may include on-chip memory 1512′. In some aspects, the CU 1510 may further include additional memory modules 1514 and a communications interface 1518. The CU 1510 communicates with the DU 1530 through a midhaul link, such as an F1 interface. The DU 1530 may include a DU processor 1532. The DU processor 1532 may include on-chip memory 1532′. In some aspects, the DU 1530 may further include additional memory modules 1534 and a communications interface 1538. The DU 1530 communicates with the RU 1540 through a fronthaul link. The RU 1540 may include an RU processor 1542. The RU processor 1542 may include on-chip memory 1542′. In some aspects, the RU 1540 may further include additional memory modules 1544, one or more transceivers 1546, antennas 1580, and a communications interface 1548. The RU 1540 communicates with the UE 104. The on-chip memory 1512′, 1532′, 1542′ and the additional memory modules 1514, 1534, 1544 may each be considered a computer-readable medium/memory. Each computer-readable medium/memory may be non-transitory. Each of the processors 1512, 1532, 1542 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to receive, from a UE, an adaptation capability, where the adaptation capability indicates at least one Tx capability of the UE for layer adaptation of the Tx of the UE in JCS. The component 199 may also be configured to provide, for the UE and based on the adaptation capability, a layer configuration for at least one of a first set of layers or a second set of layers. The component 199 may also be configured to provide, for the UE, a layer schedule, where the layer schedule is associated with the adaptation capability and indicates the UE is scheduled for communication functions and sensing operations in JCS. The component 199 may also be configured to provide, for the UE via at least one of a MAC-CE or DCI, a bandwidth part switch indication that indicates a switch to the first bandwidth part or the second bandwidth part for the UE. The component 199 may also be configured to provide, for the UE, the mode switch indication for the detection mode or the tracking mode. The component 199 may also be configured to provide, for the UE, a bandwidth part switch indication associated with one of the at least one bandwidth part for the detection mode or the tracking mode. The component 199 may also be configured to provide, for the UE, a layer activation associated with one of the at least one bandwidth part that is respectively associated with the first number of sensing layers for the detection mode or the second number of sensing layers for the tracking mode. The component 199 may also be configured to receive sensing layer information associated with monostatic sensing at the UE via at least one layer of the first set of layers. The component 199 may be further configured to perform any of the aspects described in connection with the flowchart in any of FIGS. 10, 11, 12, 13 and/or any of the aspects performed by a UE in association with any of FIGS. 6-9. The component 199 may be within one or more processors of one or more of the CU 1510, DU 1530, and the RU 1540. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1502 may include a variety of components configured for various functions. In one configuration, the network entity 1502 may include means for receiving, from a UE, an adaptation capability, where the adaptation capability indicates at least one Tx capability of the UE for layer adaptation of the Tx of the UE in JCS. In one configuration, the network entity 1502 may include means for providing, for the UE and based on the adaptation capability, a layer configuration for at least one of a first set of layers or a second set of layers. In one configuration, the network entity 1502 may include means for providing, for the UE, a layer schedule, where the layer schedule is associated with the adaptation capability and indicates the UE is scheduled for communication functions and sensing operations in JCS. In one configuration, the network entity 1502 may include means for providing, for the UE via at least one of a MAC-CE or DCI, a bandwidth part switch indication that indicates a switch to the first bandwidth part or the second bandwidth part for the UE. In one configuration, the network entity 1502 may include means for providing, for the UE, the mode switch indication for the detection mode or the tracking mode. In one configuration, the network entity 1502 may include means for providing, for the UE, a bandwidth part switch indication associated with one of the at least one bandwidth part for the detection mode or the tracking mode. In one configuration, the network entity 1502 may include means for providing, for the UE, a layer activation associated with one of the at least one bandwidth part that is respectively associated with the first number of sensing layers for the detection mode or the second number of sensing layers for the tracking mode. In one configuration, the network entity 1502 may include means for receiving sensing layer information associated with monostatic sensing at the UE via at least one layer of the first set of layers. The means may be the component 199 of the network entity 1502 configured to perform the functions recited by the means. As described supra, the network entity 1502 may include the TX processor 316, the RX processor 370, and the controller/processor 375. As such, in one configuration, the means may be the TX processor 316, the RX processor 370, and/or the controller/processor 375 configured to perform the functions recited by the means.

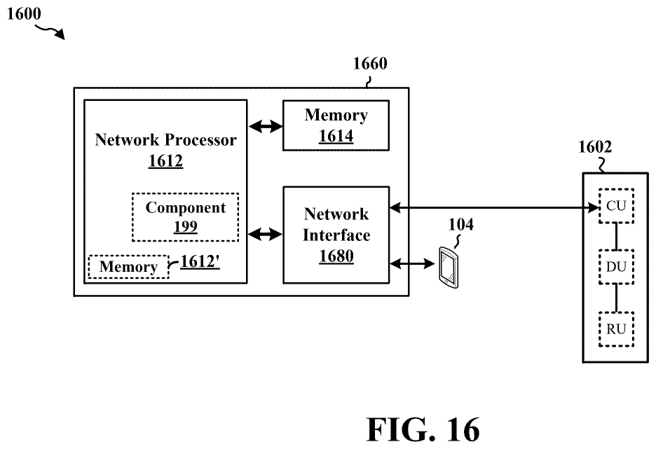

FIG. 16 is a diagram 1600 illustrating an example of a hardware implementation for a network entity 1660. In one example, the network entity 1660 may be within the core network 120. The network entity 1660 may include a network processor 1612. The network processor 1612 may include on-chip memory 1612′. In some aspects, the network entity 1660 may further include additional memory modules 1614. The network entity 1660 communicates via the network interface 1680 directly (e.g., backhaul link) or indirectly (e.g., through a RIC) with the CU 1602. The on-chip memory 1612′ and the additional memory modules 1614 may each be considered a computer-readable medium/memory. Each computer-readable medium/memory may be non-transitory. The processor 1612 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to receive, from a UE, an adaptation capability, where the adaptation capability indicates at least one Tx capability of the UE for layer adaptation of the Tx of the UE in JCS. The component 199 may also be configured to provide, for the UE and based on the adaptation capability, a layer configuration for at least one of a first set of layers or a second set of layers. The component 199 may be further configured to perform any of the aspects described in connection with the flowchart in any of FIGS. 10, 11, 12, 13 and/or any of the aspects performed by a UE in association with any of FIGS. 6-9. The component 199 may be within the processor 1612. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1660 may include a variety of components configured for various functions. In one configuration, the network entity 1660 may include means for receiving, from a UE, an adaptation capability, where the adaptation capability indicates at least one Tx capability of the UE for layer adaptation of the Tx of the UE in JCS. In one configuration, the network entity 1660 may include means for providing, for the UE and based on the adaptation capability, a layer configuration for at least one of a first set of layers or a second set of layers. In one configuration, the network entity 1660 may include means for providing, for the UE, a layer schedule, where the layer schedule is associated with the adaptation capability and indicates the UE is scheduled for communication functions and sensing operations in JCS. In one configuration, the network entity 1660 may include means for providing, for the UE via at least one of a MAC-CE or DCI, a bandwidth part switch indication that indicates a switch to the first bandwidth part or the second bandwidth part for the UE. In one configuration, the network entity 1660 may include means for providing, for the UE, the mode switch indication for the detection mode or the tracking mode. In one configuration, the network entity 1660 may include means for providing, for the UE, a bandwidth part switch indication associated with one of the at least one bandwidth part for the detection mode or the tracking mode. In one configuration, the network entity 1660 may include means for providing, for the UE, a layer activation associated with one of the at least one bandwidth part that is respectively associated with the first number of sensing layers for the detection mode or the second number of sensing layers for the tracking mode. In one configuration, the network entity 1660 may include means for receiving sensing layer information associated with monostatic sensing at the UE via at least one layer of the first set of layers. The means may be the component 199 of the network entity 1660 configured to perform the functions recited by the means.

A wireless device (e.g., a sensing node such as a UE, a base station, a gNB, etc.) on a wireless communication network, and/or the like, may utilize JCS operations for communications and sensing. Configuring multiple layers for communication operations may increase information throughput, such as for data and control information. For MIMO operations, configurations such as SU MIMO and MU-MIMO may include transmitted signals with multiple layers. Similarly, signals transmitted via OFDM may include multiple layers. However, configuring multiple layers for sensing operations may increase information throughput, however, it may also result in higher inter-layer interference therebetween and impact sensing performance (e.g., utilized power, accuracy, etc.). That is, the inter-layer interference may be proportional to the number of layers in the sensing operations, and the power utilized by a sensing device/node may be increased with multiple layers to maintain a desired SNR/SINR. Further, the handling of inter-layer interference between layers may impact the performance of wireless systems and devices in, and on, a wireless communication network. For instance, increased complexity and time for inter-layer interference cancellation processing may impact system and device efficiency/performance, and may also increase delays in signal transmissions.

The aspects herein for multi-layer adaptation to enhance JCS performance enable wireless network devices (e.g., sensing nodes) to more accurately and efficiently perform multi-layer sensing for JCS. For example, a sensing node (e.g., apparatus, device, etc.) may provide, for a SMF, an adaptation capability, where the adaptation capability indicates at least one Tx capability of the UE for layer adaptation of the Tx of the UE in JCS. The sensing node may also receive, based on the adaptation capability, a layer configuration for at least one of a first set of layers or a second set of layers. The sensing node may further perform, based on the layer configuration, at least one of (1) a communication function, with a network node, via the first set of layers or (2) a sensing operation via the second set of layers in a detection mode or in a tracking mode. As another example, a network entity (e.g., a base station, gNB, SMF, etc.) may receive, from a UE, an adaptation capability, where the adaptation capability indicates at least one Tx capability of the sensing node for layer adaptation of the Tx of the UE in JCS. The network entity may also provide, for the UE and based on the adaptation capability, a layer configuration for at least one of a first set of layers or a second set of layers.

In aspects described herein, by providing a SMF with an adaptation capability that indicates at least one Tx capability of the sensing node for layer adaptation of the Tx of the sensing node in JCS, the described techniques can be used to adaptively configure layers for sensing operations at sensing nodes to reduce the inter-layer interference thereof and to reduce power utilization. Further, by providing different implementations for triggering adaptive layers, sensing and sensing node performance improvements are enabled for multiple sensing scenarios, and by providing flexible adaptation for layers, the extensible layer configurations herein are applicable to multiple sensing capabilities of sensing nodes, to monostatic and bistatic sensing, and to detection and tracking modes in sensing operations. Moreover, by providing sensing layer information, a wireless network and/or devices thereon (e.g., a base station, a sidelink UE, etc.) may adjust/improve multi-layer interference at sensing nodes and enhance sensing and communication performance.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a user equipment (UE), comprising: providing, for a sensing management functionality (SMF), an adaptation capability, wherein the adaptation capability indicates at least one transmitter (Tx) capability of the UE for layer adaptation of the Tx of the UE in joint communication-sensing (JCS); receiving, based on the adaptation capability, a layer configuration for at least one of a first set of layers or a second set of layers; and performing, based on the layer configuration, at least one of (1) a communication function, with a network node, via the first set of layers or (2) a sensing operation via the second set of layers in a detection mode or in a tracking mode.

Aspect 2 is the method of aspect 1, wherein the adaptation capability indicates the at least one Tx capability of the UE as: a first indication of support for multiple input multiple output (MIMO)-layers sharing in the JCS for the Tx of the UE; a second indication of a first maximum number of layers for the sensing operation while the MIMO-layers sharing is enabled; a third indication of a second maximum number of layers for the sensing operation in the detection mode; or a fourth indication of a third maximum number of layers for the sensing operation in the tracking mode.

Aspect 3 is the method of aspects 1 or 2, further comprising: receiving, from the SMF, a layer schedule, wherein the layer schedule is associated with the adaptation capability and indicates the UE is scheduled for communication functions and sensing operations in JCS; wherein the adaptation capability further indicates at least one receiver (Rx) capability of the UE for the layer adaptation of the Rx of the UE for multiple input multiple output (MIMO)-layers sharing in the JCS, wherein the MIMO-layers sharing in the JCS is associated with at least one of communication layers or sensing layers.

Aspect 4 is the method of aspect 3, wherein the Rx capability of the UE for the layer adaptation of the Rx of the UE for the MIMO-layers sharing in the JCS associated with the communication layers indicates at least one of: a first indication of support for the communication layers when the sensing layers are simultaneously enabled; or a second indication of support to handle inter-layer interference in the communication layers from the sensing layers.

Aspect 5 is the method of aspect 3, wherein the Rx capability of the UE for the layer adaptation of the Rx of the UE for the MIMO-layers sharing in the JCS associated with the sensing layers indicates at least one of: a first indication of support for the sensing layers when the communication layers are simultaneously enabled; or a second indication of support to handle inter-layer interference in the sensing layers from the communication layers.

Aspect 6 is the method of any of aspects 1 to 5, wherein the layer configuration indicates, for the second set of layers, at least one of a first number of sensing layers for the detection mode or a second number of sensing layers for the tracking mode, and wherein the layer configuration is further associated with a UE traffic characteristic.

Aspect 7 is the method of any of aspects 1 to 6, wherein receiving the layer configuration comprises receiving, from the SMF via radio resource control (RRC) signaling, the layer configuration, wherein the layer configuration indicates, for the second set of layers, at least one of a first bandwidth part associated with a first number of sensing layers for the detection mode or a second bandwidth part associated with a second number of sensing layers for the tracking mode; the method further comprising: receiving, from the SMF via at least one of a medium access control (MAC) control element (MAC-CE) or downlink control information (DCI), a bandwidth part switch indication; and switching to the first bandwidth part or the second bandwidth part based on the bandwidth part switch indication.

Aspect 8 is the method of any of aspects 1 to 6, wherein receiving the layer configuration comprises receiving, from the SMF, the layer configuration, wherein the layer configuration indicates at least one of: a mode switch indication, to the detection mode or the tracking mode, associated with at least one of radio resource control (RRC) signaling, a medium access control (MAC) control element (MAC-CE), or downlink control information (DCI), at least one bandwidth part respectively associated with the detection mode or the tracking mode, or a first number of sensing layers for the detection mode or a second number of sensing layers for the tracking mode; and activating the detection mode or the tracking mode based on the layer configuration.

Aspect 9 is the method of aspect 8, wherein activating the detection mode or the tracking mode based on the layer configuration comprises activating the detection mode or the tracking mode based on the layer configuration and the mode switch indication.

Aspect 10 is the method of aspect 8, wherein activating the detection mode or the tracking mode based on the layer configuration comprises activating the detection mode or the tracking mode based on a bandwidth part switch associated with one of the at least one bandwidth part respectively associated with the detection mode or the tracking mode.

Aspect 11 is the method of aspect 8, wherein activating the detection mode or the tracking mode based on the layer configuration comprises activating the detection mode or the tracking mode based on the layer configuration associated with one of the at least one bandwidth part that is respectively associated with the first number of sensing layers for the detection mode or the second number of sensing layers for the tracking mode.

Aspect 12 is the method of any one of aspects 1 to 6, wherein receiving the layer configuration comprises receiving, from the SMF or the network node via at least one layer of the first set of layers, the layer configuration, wherein the layer configuration indicates at least one of: a first indication of support for multiple input multiple output (MIMO)-layers sharing in the JCS for the Tx of the UE; a first number of sensing layers associated with the detection mode; a second number of sensing layers associated with the tracking mode; or at least one waveform respectively associated with at least one of the detection mode or the tracking mode.

Aspect 13 is the method of any of aspects 1 to 12, wherein performing the sensing operation comprises sensing via monostatic sensing; wherein the method further comprises: providing sensing layer information associated with the monostatic sensing via at least one layer of the first set of layers.

Aspect 14 is the method of aspect 13, wherein the sensing layer information comprises at least one of: a status indication of multiple input multiple output (MIMO)-layers sharing in the JCS for the UE; a first number of sensing layers associated with the detection mode, a second number of sensing layers associated with the tracking mode, or at least one waveform respectively associated with at least one of the detection mode or the tracking mode; wherein providing the sensing layer information comprises providing the sensing layer information for at least one of (i) the network node via a UE-to-universal mobile telecommunications system (UMTS) terrestrial radio access network (UTRAN) (Uu) interface or (ii) another UE via a sidelink connection.

Aspect 15 is a method of wireless communication at a network entity, comprising: receiving, from a user equipment (UE), an adaptation capability, wherein the adaptation capability indicates at least one transmitter (Tx) capability of the UE for layer adaptation of the Tx of the UE in joint communication-sensing (JCS); and providing, for the UE and based on the adaptation capability, a layer configuration for at least one of a first set of layers or a second set of layers.

Aspect 16 is the method of aspect 15, wherein the adaptation capability indicates the at least one Tx capability of the UE as: a first indication of support for multiple input multiple output (MIMO)-layers sharing in the JCS for the Tx of the UE; a second indication of a first maximum number of layers for a sensing operation while the MIMO-layers sharing is enabled; a third indication of a second maximum number of layers for the sensing operation in a detection mode; or a fourth indication of a third maximum number of layers for the sensing operation in a tracking mode.

Aspect 17 is the method of aspect 15 or 16, further comprising: providing, for the UE, a layer schedule, wherein the layer schedule is associated with the adaptation capability and indicates the UE is scheduled for communication functions and sensing operations in JCS; wherein the adaptation capability further indicates at least one receiver (Rx) capability of the UE for the layer adaptation of the Rx of the UE for multiple input multiple output (MIMO)-layers sharing in the JCS, wherein the MIMO-layers sharing in the JCS is associated with at least one of communication layers or sensing layers.

Aspect 18 is the method of aspect 17, wherein the Rx capability of the UE for the layer adaptation of the Rx of the UE for the MIMO-layers sharing in the JCS associated with the communication layers indicates at least one of: a first indication of support for the communication layers when the sensing layers are simultaneously enabled; or a second indication of support to handle inter-layer interference in the communication layers from the sensing layers.

Aspect 19 is the method of aspect 17, wherein the Rx capability of the UE for the layer adaptation of the Rx of the UE for the MIMO-layers sharing in the JCS associated with the sensing layers indicates at least one of: a first indication of support for the sensing layers when the communication layers are simultaneously enabled; or a second indication of support to handle inter-layer interference in the sensing layers from the communication layers.

Aspect 20 is the method of any of aspects 15 to 19, wherein the layer configuration indicates, for the second set of layers, at least one of a first number of sensing layers for a detection mode or a second number of sensing layers for a tracking mode, and wherein the layer configuration is further associated with a UE traffic characteristic.

Aspect 21 is the method of any of aspects 15 to 20, wherein providing the layer configuration includes providing, for the UE via radio resource control (RRC) signaling, the layer configuration, wherein the layer configuration indicates, for the second set of layers, at least one of a first bandwidth part associated with a first number of sensing layers for a detection mode or a second bandwidth part associated with a second number of sensing layers for a tracking mode; the method further comprising: providing, for the UE via at least one of a medium access control (MAC) control element (MAC-CE) or downlink control information (DCI), a bandwidth part switch indication that indicates a switch to the first bandwidth part or the second bandwidth part for the UE.

Aspect 22 is the method of any of aspects 15 to 21, wherein the layer configuration indicates at least one of: a mode switch indication, to a detection mode or a tracking mode, associated with at least one of radio resource control (RRC) signaling, a medium access control (MAC) control element (MAC-CE), or downlink control information (DCI), at least one bandwidth part respectively associated with the detection mode or the tracking mode, or a first number of sensing layers for the detection mode or a second number of sensing layers for the tracking mode; and wherein at least one of (i) the mode switch indication, (ii) the at least one bandwidth part, or (iii) the first or second number of sensing layers are associated with an activation of the detection mode or the tracking mode for the UE.

Aspect 23 is the method of aspect 22, further comprising: providing, for the UE, the mode switch indication for the detection mode or the tracking mode.

Aspect 24 is the method of aspect 22, further comprising: providing, for the UE, a bandwidth part switch indication associated with one of the at least one bandwidth part for the detection mode or the tracking mode.

Aspect 25 is the method of aspect 22, further comprising: providing, for the UE, a layer activation associated with one of the at least one bandwidth part that is respectively associated with the first number of sensing layers for the detection mode or the second number of sensing layers for the tracking mode.

Aspect 26 is the method of any of aspects 15 to 20, wherein providing the layer configuration includes providing the layer configuration via at least one layer of the first set of layers, wherein the layer configuration indicates at least one of: a first indication of support for multiple input multiple output (MIMO)-layers sharing in the JCS for the Tx of the UE; a first number of sensing layers associated with a detection mode; a second number of sensing layers associated with a tracking mode; or at least one waveform respectively associated with at least one of the detection mode or the tracking mode.

Aspect 27 is the method of claim 15, further comprising: receiving sensing layer information associated with monostatic sensing at the UE via at least one layer of the first set of layers.

Aspect 28 is the method of claim 27, wherein the sensing layer information includes at least one of: a status indication of multiple input multiple output (MIMO)-layers sharing in the JCS for the UE; a first number of sensing layers associated with a detection mode, a second number of sensing layers associated with a tracking mode, or at least one waveform respectively associated with at least one of the detection mode or the tracking mode; wherein receiving the sensing layer information includes receiving the sensing layer information via a UE-to-universal mobile telecommunications system (UMTS) terrestrial radio access network (UTRAN) (Uu) interface.

Aspect 29 is an apparatus for wireless communication including means for implementing any of aspects 1 to 14.

Aspect 30 is a computer-readable medium (e.g., a non-transitory computer-readable medium) storing computer executable code, the code when executed by at least one processor causes the at least one processor, individually or in any combination, to implement any of aspects 1 to 14.

Aspect 31 is an apparatus for wireless communication at a network node. The apparatus includes at least one memory; and at least one processor coupled to the at least one memory and, based at least in part on information stored in the at least one memory, the at least one processor, individually or in any combination, is configured to implement any of aspects 1 to 14.

Aspect 32 is the apparatus of aspect 31, further including at least one of a transceiver or an antenna coupled to the at least one processor.

Aspect 33 is an apparatus for wireless communication including means for implementing any of aspects 15 to 28.

Aspect 34 is a computer-readable medium (e.g., a non-transitory computer-readable medium) storing computer executable code, the code when executed by at least one processor causes the at least one processor, individually or in any combination, to implement any of aspects 15 to 28.

Aspect 35 is an apparatus for wireless communication at a network node. The apparatus includes at least one memory; and at least one processor coupled to the at least one memory and, based at least in part on information stored in the at least one memory, the at least one processor, individually or in any combination, is configured to implement any of aspects 15 to 28.

Aspect 36 is the apparatus of aspect 35, further including at least one of a transceiver or an antenna coupled to the at least one processor.

1. An apparatus for wireless communication at a user equipment (UE), comprising:
at least one memory; and
at least one processor coupled to the at least one memory and, based at least in part on information stored in the at least one memory, the at least one processor, individually or in any combination, is configured to:
provide, for a sensing management functionality (SMF), an adaptation capability, wherein the adaptation capability indicates at least one transmitter (Tx) capability of the UE for layer adaptation of the Tx of the UE in joint communication-sensing (JCS);
receive, based on the adaptation capability, a layer configuration for at least one of a first set of layers or a second set of layers; and
perform, based on the layer configuration, at least one of (1) a communication function, with a network node, via the first set of layers or (2) a sensing operation via the second set of layers in a detection mode or in a tracking mode.

2. The apparatus of claim 1, wherein the adaptation capability indicates the at least one Tx capability of the UE as:
a first indication of support for multiple input multiple output (MIMO)-layers sharing in the JCS for the Tx of the UE;
a second indication of a first maximum number of layers for the sensing operation while the MIMO-layers sharing is enabled;
a third indication of a second maximum number of layers for the sensing operation in the detection mode; or
a fourth indication of a third maximum number of layers for the sensing operation in the tracking mode.

3. The apparatus of claim 1, wherein the at least one processor, individually or in any combination, is further configured to:
receive, from the SMF, a layer schedule, wherein the layer schedule is associated with the adaptation capability and indicates the UE is scheduled for communication functions and sensing operations in JCS;
wherein the adaptation capability further indicates at least one receiver (Rx) capability of the UE for the layer adaptation of the Rx of the UE for multiple input multiple output (MIMO)-layers sharing in the JCS, wherein the MIMO-layers sharing in the JCS is associated with at least one of communication layers or sensing layers.

4. The apparatus of claim 3, wherein the Rx capability of the UE for the layer adaptation of the Rx of the UE for the MIMO-layers sharing in the JCS associated with the communication layers indicates at least one of:
a first indication of support for the communication layers when the sensing layers are simultaneously enabled; or
a second indication of support to handle inter-layer interference in the communication layers from the sensing layers.

5. The apparatus of claim 3, wherein the Rx capability of the UE for the layer adaptation of the Rx of the UE for the MIMO-layers sharing in the JCS associated with the sensing layers indicates at least one of:
a first indication of support for the sensing layers when the communication layers are simultaneously enabled; or
a second indication of support to handle inter-layer interference in the sensing layers from the communication layers.

6. The apparatus of claim 1, wherein the layer configuration indicates, for the second set of layers, at least one of a first number of sensing layers for the detection mode or a second number of sensing layers for the tracking mode, and wherein the layer configuration is further associated with a UE traffic characteristic.

7. The apparatus of claim 1, wherein to receive the layer configuration, the at least one processor, individually or in any combination, is configured to receive, from the SMF via radio resource control (RRC) signaling, the layer configuration, wherein the layer configuration indicates, for the second set of layers, at least one of a first bandwidth part associated with a first number of sensing layers for the detection mode or a second bandwidth part associated with a second number of sensing layers for the tracking mode;
wherein the at least one processor, individually or in any combination, is further configured to:
receive, from the SMF via at least one of a medium access control (MAC) control element (MAC-CE) or downlink control information (DCI), a bandwidth part switch indication; and
switch to the first bandwidth part or the second bandwidth part based on the bandwidth part switch indication.

8. The apparatus of claim 1, wherein to receive the layer configuration, the at least one processor, individually or in any combination, is configured to receive, from the SMF, the layer configuration, wherein the layer configuration indicates at least one of:
a mode switch indication, to the detection mode or the tracking mode, associated with at least one of radio resource control (RRC) signaling, a medium access control (MAC) control element (MAC-CE), or downlink control information (DCI),
at least one bandwidth part respectively associated with the detection mode or the tracking mode, or
a first number of sensing layers for the detection mode or a second number of sensing layers for the tracking mode; and
wherein the at least one processor, individually or in any combination, is further configured to: activate the detection mode or the tracking mode based on the layer configuration.

9. The apparatus of claim 8, wherein to activate the detection mode or the tracking mode based on the layer configuration, the at least one processor, individually or in any combination, is configured to activate the detection mode or the tracking mode based on the layer configuration and the mode switch indication.

10. The apparatus of claim 8, wherein to activate the detection mode or the tracking mode based on the layer configuration, the at least one processor, individually or in any combination, is configured to activate the detection mode or the tracking mode based on a bandwidth part switch associated with one of the at least one bandwidth part respectively associated with the detection mode or the tracking mode.

11. The apparatus of claim 8, wherein to activate the detection mode or the tracking mode based on the layer configuration, the at least one processor, individually or in any combination, is configured to activate the detection mode or the tracking mode based on the layer configuration associated with one of the at least one bandwidth part that is respectively associated with the first number of sensing layers for the detection mode or the second number of sensing layers for the tracking mode.

12. The apparatus of claim 1, wherein to receive the layer configuration, the at least one processor, individually or in any combination, is configured to receive, from the SMF or the network node via at least one layer of the first set of layers, the layer configuration, wherein the layer configuration indicates at least one of:
a first indication of support for multiple input multiple output (MIMO)-layers sharing in the JCS for the Tx of the UE;
a first number of sensing layers associated with the detection mode;
a second number of sensing layers associated with the tracking mode; or
at least one waveform respectively associated with at least one of the detection mode or the tracking mode.

13. The apparatus of claim 1, wherein to perform the sensing operation, the at least one processor, individually or in any combination, is configured to sense via monostatic sensing;
wherein the at least one processor, individually or in any combination, is further configured to:
provide sensing layer information associated with the monostatic sensing via at least one layer of the first set of layers.

14. The apparatus of claim 13, wherein the sensing layer information includes at least one of:
a status indication of multiple input multiple output (MIMO)-layers sharing in the JCS for the UE;
a first number of sensing layers associated with the detection mode,
a second number of sensing layers associated with the tracking mode, or
at least one waveform respectively associated with at least one of the detection mode or the tracking mode;
wherein to provide the sensing layer information, the at least one processor, individually or in any combination, is configured to provide the sensing layer information for at least one of (i) the network node via a UE-to-universal mobile telecommunications system (UMTS) terrestrial radio access network (UTRAN) (Uu) interface or (ii) another UE via a sidelink connection.

15. An apparatus for wireless communication at a network entity, comprising:
at least one memory; and
at least one processor coupled to the at least one memory and, based at least in part on information stored in the at least one memory, the at least one processor, individually or in any combination, is configured to:
receive, from a user equipment (UE), an adaptation capability, wherein the adaptation capability indicates at least one transmitter (Tx) capability of the UE for layer adaptation of the Tx of the UE in joint communication-sensing (JCS); and
provide, for the UE and based on the adaptation capability, a layer configuration for at least one of a first set of layers or a second set of layers.

16. The apparatus of claim 15, wherein the adaptation capability indicates the at least one Tx capability of the UE as:
a first indication of support for multiple input multiple output (MIMO)-layers sharing in the JCS for the Tx of the UE;
a second indication of a first maximum number of layers for a sensing operation while the MIMO-layers sharing is enabled;
a third indication of a second maximum number of layers for the sensing operation in a detection mode; or
a fourth indication of a third maximum number of layers for the sensing operation in a tracking mode.

17. The apparatus of claim 15, wherein the at least one processor, individually or in any combination, is further configured to:
provide, for the UE, a layer schedule, wherein the layer schedule is associated with the adaptation capability and indicates the UE is scheduled for communication functions and sensing operations in JCS;
wherein the adaptation capability further indicates at least one receiver (Rx) capability of the UE for the layer adaptation of the Rx of the UE for multiple input multiple output (MIMO)-layers sharing in the JCS, wherein the MIMO-layers sharing in the JCS is associated with at least one of communication layers or sensing layers.

18. The apparatus of claim 17, wherein the Rx capability of the UE for the layer adaptation of the Rx of the UE for the MIMO-layers sharing in the JCS associated with the communication layers indicates at least one of:
a first indication of support for the communication layers when the sensing layers are simultaneously enabled; or
a second indication of support to handle inter-layer interference in the communication layers from the sensing layers.

19. The apparatus of claim 17, wherein the Rx capability of the UE for the layer adaptation of the Rx of the UE for the MIMO-layers sharing in the JCS associated with the sensing layers indicates at least one of:
a first indication of support for the sensing layers when the communication layers are simultaneously enabled; or
a second indication of support to handle inter-layer interference in the sensing layers from the communication layers.

20-28. (canceled)

29. A method of wireless communication at a user equipment (UE), comprising:
providing, for a sensing management functionality (SMF), an adaptation capability, wherein the adaptation capability indicates at least one transmitter (Tx) capability of the UE for layer adaptation of the Tx of the UE in joint communication-sensing (JCS);
receiving, based on the adaptation capability, a layer configuration for at least one of a first set of layers or a second set of layers; and
performing, based on the layer configuration, at least one of (1) a communication function, with a network node, via the first set of layers or (2) a sensing operation via the second set of layers in a detection mode or in a tracking mode.

30. (canceled)
